(19) United States
(12) Patent Application Publication
(10) Pub. No.: US 2018/0173665 A1
(43) Pub. Date: Jun. 21, 2018

(54) HARD RESET OVER I3C BUS

(71) Applicant: QUALCOMM Incorporated, San Diego, CA (US)

(72) Inventors: Lalan Jee Mishra, San Diego, CA (US); Radu Pitigoi-Aron, San Jose, CA (US); Richard Dominic Wietfeldt, San Diego, CA (US)

(21) Appl. No.: 15/382,102

(22) Filed: Dec. 16, 2016

(51) Int. Cl. G06F 13/42; G06F 13/364; G06F 13/40

(52) U.S. Cl. CPC G06F 13/4282; G06F 13/404; G06F 13/364

(57) ABSTRACT

Systems, methods, and apparatus are described that enable communication of in-band reset signals over a serial bus. A method performed at a slave device coupled to the serial bus includes configuring a reset controller to operate in one of plural modes, identifying a first reset pattern in signaling received from a multi-wire serial bus, complying with one or more transmissions defined by the protocol, asserting a reset input of a processing circuit in the slave device responsive to an identification of the first reset pattern when the reset controller is operated in a first mode, and ignoring the first reset pattern when the reset controller is operated in a second mode. The signaling received from the multi-wire serial bus may include one or more transmissions defined by a protocol used on the multi-wire serial bus. The reset controller may operate autonomously from the processing circuit in the first mode.

### TECHNICAL FIELD

The present disclosure relates generally to an interface between processing circuits and peripheral devices and, more particularly, to providing a hard reset capability through signaling on a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derives certain implementation aspects from the I2C protocol. Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. Other protocols, such as the I3C protocol, can increase available bandwidth on the serial bus through higher transmitter clock rates, by encoding data in signaling state of two or more wires, and through other encoding techniques. Certain aspects of the I3C protocol are derived from corresponding aspects of the I2C protocol, and the I2C and I3C protocols can coexist on the same serial bus.

In another example, the System Management Bus (SMBus) is a single-ended two-wire bus derived from the I2C bus. The SMBus may be used to provide low-bandwidth, simplified communications from a processor to components. For example, the SMBus may carry on-off signaling between a processor and a power supply.

In another example, the serial peripheral interface (SPI) is a general-purpose serial interface that may be included in mobile communication devices to provide synchronous serial communication between a processor and various peripheral devices. In one example, an SPI master device is coupled through the SPI bus to peripheral devices configured as slave SPI devices. The master device provides a clock signal on a clock line of the SPI bus, where the clock signal controls synchronous serial data exchanges between the master and slave devices. Data may be communicated using two or more data lines of the SPI bus. Since one or more of the data lines may be shared by multiple slave devices, the SPI bus provides a slave select line for each slave device to control access to shared data lines.

Conventionally, devices coupled to a serial data bus may support out-of-band signaling, such as reset signals sent by a master device using dedicated signal wires or traces. Dedicated reset signal wires are increasingly unavailable to designers as functionality of mobile communication devices escalate. Accordingly, improvements are continually needed to improve data throughput and provide alternatives to out-of-band signaling.

### SUMMARY

Certain aspects of the disclosure relate to systems, apparatus, methods and techniques that provide a master device on an I3C bus with the ability to selectively reset slave devices coupled to a serial bus.

In various aspects of the disclosure, a method performed at a slave device coupled to the serial bus includes configuring a reset controller to operate in one of a plurality of modes, and identifying a first reset pattern in signaling received from a multi-wire serial bus, where the signaling received from the multi-wire serial bus may include one or more transmissions defined by a protocol used on the multi-wire serial bus. The method may include complying with the one or more transmissions defined by the protocol, asserting a reset input of a processing circuit in the slave device responsive to an identification of the first reset pattern when the reset controller is operated in a first mode, and ignoring the first reset pattern when the reset controller is operated in a second mode. The first reset pattern may be configured to be ignored by processing circuits implementing one or more protocols on slave devices coupled to the multi-wire serial bus. For example, the first reset pattern may be ignored by a slave device that is operating in accordance with I2C protocols. The reset controller may operate autonomously from the processing circuit in the slave device when operated in the first mode.

In one aspect, configuring the reset controller includes configuring a reset address corresponding to the slave device in a first register of the reset controller, and configuring a gating value in a second register of the reset controller. The second register may be one of a plurality of registers that may be configured with a gating value. The reset controller may operate in the second mode when the first register and the second register have the same value. The reset controller may operate autonomously in the first mode when the first register and the second register have different values.

In some examples, the reset controller may configure one or more reset addresses in one or more reset address registers of the reset controller, and may configure a gating value in a gate register of the reset controller. The reset controller may operate in the second mode when the one or more reset address registers and the gate register have a same value. The reset controller may operate autonomously in the first mode when at least one reset address register and the gate register have different values.

In some examples, the reset controller may configure a reset address in a reset address register of the reset controller, and may configure one or more gating values in one or more gate registers of the reset controller. The reset controller may operate in the second mode when the reset address register and the one or more gate registers have a same value. The reset controller may operate autonomously in the first mode when the reset address register and at least one gate register have different values.

The reset controller may operate autonomously in the first mode after a power-on initialization of the first device.

In some aspects, operation of the processing circuit in the slave device may be modified based on information encoded in a second reset pattern provided in the signaling received from the multi-wire serial bus. In one example, an identifier may be decoded from the second reset pattern using a pulse width modulation decoder. The reset input of the processing circuit in the slave device may be asserted when the identifier is associated with the slave device. In another example, a command code may be decoded from the second reset pattern using a pulse width modulation decoder, and operation of the processing circuit in the slave device may be modified based on the command code. The processing circuit in the slave device may enter a sleep mode of operation in response to the command code. The reset controller may remain powered on and operating autonomously from the processing circuit in the slave device when the processing circuit in the slave device has entered a sleep mode of operation.

In one aspect, the signaling received from the multi-wire serial bus includes one or more transmissions defined by an I2C protocol, an I3C protocol, an SMBus protocol and/or an SPI protocol.

In various aspects of the disclosure, an apparatus adapted or configured to function as a slave device coupled to a serial bus includes a reset controller configured to operate autonomously in the slave device and an interface to the serial bus. The apparatus may include means for configuring a reset controller to operate in one of a plurality of modes, and means for identifying a first reset pattern in signaling received from a multi-wire serial bus, where the signaling received from the multi-wire serial bus may include one or more transmissions defined by a protocol used on the multi-wire serial bus. The apparatus may include means for complying with the one or more transmissions defined by the protocol, means for asserting a reset input of a processing circuit in the slave device responsive to an identification of the first reset pattern when the reset controller is operated in a first mode, and means for ignoring the first reset pattern when the reset controller is operated in a second mode. The first reset pattern may be configured to be ignored by processing circuits implementing one or more protocols on slave devices coupled to the multi-wire serial bus. For example, the first reset pattern may be ignored by a slave device that is operating in accordance with I2C protocols. The reset controller may operate autonomously from the processing circuit in the slave device when operated in the first mode.

In various aspects of the disclosure, a method performed at a host device coupled to a serial bus includes transmitting a first register value to a first slave device, where the first register value is selected to cause a reset controller in the first slave device to be configured to operate in a first mode. The method may include transmitting a second register value to a second slave device, where the second register value is selected to cause a reset controller in the second slave device to be configured to operate in a second mode autonomously from a processing circuit in the second device. The method may include providing a first reset pattern in signaling transmitted over the serial bus. The first reset pattern may be ignored by the first device and may cause the reset controller in the second slave device to reset the processing circuit in the second slave device. The method may include transmitting register values to the first slave device and the second slave device that are selected to cause respective reset controllers in the first slave device and the second slave device to be configured to operate in the second mode autonomously from their respective processing circuits. The signaling may include one or more transmissions defined by a protocol used on the multi-wire serial bus.

In one aspect, the first reset pattern is configured to be ignored by processing circuits implementing one or more protocols on slave devices coupled to the multi-wire serial bus. For example, the first reset pattern is ignored by a slave device that is operating in accordance with I2C protocols.

In some aspects, the first register value includes a gating value identical to a first identifier maintained by the reset controller in the first slave device. The second register value may include a gating value identical to a second identifier maintained by the reset controller in the second slave device. Modes of operation of reset controllers in the first slave device and the second slave device are determined based on a comparison of respective identifiers and corresponding gating values. The reset controller of the first device may be configured to operate in the second mode autonomously from the processing circuit in the second device after a power-on initialization of the first device.

In some aspects, the method includes providing a second reset pattern in the signaling transmitted over the serial bus, where the second reset pattern, and encoding information in the second reset pattern that is configured to cause modification of operation of a processing circuit in at least one slave device. Encoding information in the second reset pattern may include encoding an identifier using a pulse width modulation encoder. The identifier may be selected to cause an autonomous reset controller in the at least one slave device to reset a processing circuit in the at least one slave device. Encoding information in the second reset pattern may include encoding a command code using a pulse width modulation encoder. The command code may be selected to cause an autonomous reset controller in the at least one slave device to modify an operation of a processing circuit in the at least one slave device. The command code may be selected to cause the processing circuit in the at least one slave device to enter a sleep mode of operation in response to the command. The signaling may be transmitted over the serial bus includes one or more transmissions defined by an I3C protocol.

In various aspects of the disclosure, an apparatus coupled to a serial bus includes means for transmitting a first register value to a first slave device, where the first register value is selected to cause a reset controller in the first slave device to be configured to operate in a first mode. The apparatus may include means for transmitting a second register value to a second slave device, where the second register value is selected to cause a reset controller in the second slave device to be configured to operate in a second mode autonomously from a processing circuit in the second device. The apparatus may include means for providing a first reset pattern in signaling transmitted over the serial bus. The first reset pattern may be ignored by the first device and may cause the reset controller in the second slave device to reset the processing circuit in the second slave device. The apparatus may include means for transmitting register values to the first slave device and the second slave device that are selected to cause respective reset controllers in the first slave device and the second slave device to be configured to operate in the second mode autonomously from their respective processing circuits. The signaling may include one or more transmissions defined by a protocol used on the multi-wire serial bus.

In one aspect, the first reset pattern is configured to be ignored by processing circuits implementing one or more protocols on slave devices coupled to the multi-wire serial bus. For example, the first reset pattern is ignored by a slave device that is operating in accordance with I2C protocols.

In some aspects, the first register value includes a gating value identical to a first identifier maintained by the reset controller in the first slave device. The second register value may include a gating value identical to a second identifier maintained by the reset controller in the second slave device. Modes of operation of reset controllers in the first slave device and the second slave device are determined based on a comparison of respective identifiers and corresponding gating values. The reset controller of the first device may be configured to operate in the second mode autonomously from the processing circuit in the second device after a power-on initialization of the first device.

In some aspects, the apparatus may include means for providing a second reset pattern in the signaling transmitted over the serial bus, where the second reset pattern, and encoding information in the second reset pattern that is configured to cause modification of operation of a processing circuit in at least one slave device. Information may be encoded in the second reset pattern by encoding an identifier using a pulse width modulation encoder. The identifier may be selected to cause an autonomous reset controller in the at least one slave device to reset a processing circuit in the at least one slave device. Information may be encoded in the second reset pattern by encoding a command code using a pulse width modulation encoder. The command code may be selected to cause an autonomous reset controller in the at least one slave device to modify an operation of a processing circuit in the at least one slave device. The command code may be selected to cause the processing circuit in the at least one slave device to enter a sleep mode of operation in response to the command. The signaling may be transmitted over the serial bus includes one or more transmissions defined by an I3C protocol.

In various aspects of the disclosure, a processor-readable storage medium is disclosed. The storage medium may be a non-transitory storage medium and may store code that, when executed by one or more processors, causes the one or more processors to perform one or more of the processes and/or methods disclosed herein.

In one example, the one or more processors may be provided in a slave device, and the storage medium may store code that causes the one or more processors to configure a reset controller to operate in one of a plurality of modes, and identify a first reset pattern in signaling received from a multi-wire serial bus, where the signaling received from the multi-wire serial bus may include one or more transmissions defined by a protocol used on the multi-wire serial bus. The code that causes the one or more processors to comply with the one or more transmissions defined by the protocol, assert a reset input of a processing circuit in the slave device responsive to an identification of the first reset pattern when the reset controller is operated in a first mode, and ignore the first reset pattern when the reset controller is operated in a second mode. The first reset pattern may be configured to be ignored by processing circuits implementing one or more protocols on slave devices coupled to the multi-wire serial bus. For example, the first reset pattern may be ignored by a slave device that is operating in accordance with I2C protocols. The reset controller may operate autonomously from the processing circuit in the slave device when operated in the first mode.

In another example, the one or more processors may be provided in a host or master device coupled to a serial bus, and the storage medium may store code that causes the one or more processors to transmit a first register value to a first slave device, where the first register value is selected to cause a reset controller in the first slave device to be configured to operate in a first mode. The storage medium may store code that causes the one or more processors to transmit a second register value to a second slave device, where the second register value is selected to cause a reset controller in the second slave device to be configured to operate in a second mode autonomously from a processing circuit in the second device. The storage medium may store code that causes the one or more processors to provide a first reset pattern in signaling transmitted over the serial bus. The first reset pattern may be ignored by the first device and may cause the reset controller in the second slave device to reset the processing circuit in the second slave device. The storage medium may store code that causes the one or more processors to transmit register values to the first slave device and the second slave device that are selected to cause respective reset controllers in the first slave device and the second slave device to be configured to operate in the second mode autonomously from their respective processing circuits. The signaling may include one or more transmissions defined by a protocol used on the multi-wire serial bus.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a configuration of devices coupled to a common serial bus.

FIG. 4 illustrates certain aspects of the timing relationship between SDA and SCL wires on a conventional I2C bus.

FIG. 5 illustrates timing related to a transmission sent to a slave device in accordance with I2C protocols.

FIG. 6 illustrates an example of a system that provides hard reset of peripheral devices coupled to a serial bus.

FIG. 7 illustrates a first example of a peripheral device that has been adapted in accordance with certain aspects disclosed herein.

FIG. 8 illustrates an example of signaling transmitted on the data line and clock line that may be recognized as a device reset pattern in accordance with certain aspects disclosed herein.

FIG. 9 illustrates a second example of a peripheral device that has been adapted in accordance with certain aspects disclosed herein.

FIG. 10 illustrates an example of registers that may be configured to selectively enable in-band reset in accordance with certain aspects disclosed herein.

FIG. 11 illustrates a third example of a peripheral device that has been adapted in accordance with certain aspects disclosed herein.

FIG. 12 illustrates an example of a targeted device reset pattern that may be transmitted in accordance with certain aspects disclosed herein.

FIG. 13 illustrates examples of information encoded in a pulse width modulated word encoded in a targeted device reset pattern transmitted in accordance with certain aspects disclosed herein.

FIG. 14 illustrates a fourth example of a peripheral device that has been adapted in accordance with certain aspects disclosed herein.

FIG. 15 illustrates a host device adapted to assert and support autonomous control over slave devices in accordance with certain aspects disclosed herein.

FIG. 16 is a block diagram illustrating an example of an apparatus employing a processing circuit that may be adapted according to certain aspects disclosed herein.

FIG. 17 is a flowchart illustrating the configuration of a slave device by a master device after a power-on event in accordance with certain aspects disclosed herein.

FIG. 18 is a flowchart illustrating the configuration of a plurality of slave devices by a master device to selectively cause certain of the slave devices to be reset in accordance with certain aspects disclosed herein.

FIG. 19 is a flowchart illustrating a hard-reset process implemented at a slave device and controlled through PWM-modulated signaling in accordance with certain aspects disclosed herein.

FIG. 20 is a flowchart illustrating a process that may be implemented at a host device to cause selective reset of one or more slave devices through PWM-modulated signaling in accordance with certain aspects disclosed herein.

FIG. 21 is a flowchart illustrating a process for generating control signals at a slave in response to PWM-modulated signaling in accordance with certain aspects disclosed herein.

FIG. 22 is a flowchart illustrating a process by which a host device may assert control at one or more slave devices through PWM-modulated signaling in accordance with certain aspects disclosed herein.

FIG. 23 is a flowchart illustrating certain operations of a slave device adapted to respond to multiple dynamic addresses in accordance with certain aspects disclosed herein.

FIG. 24 is a flowchart illustrating certain operations of an application processor adapted to cause slave devices to obtain multiple dynamic addresses in accordance with certain aspects disclosed herein.

FIG. 25 illustrates a hardware implementation for a slave apparatus adapted to respond to a reset pattern in accordance with certain aspects disclosed herein.

FIG. 26 illustrates a hardware implementation for a host apparatus adapted to generate and transmit a reset pattern in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect application processor or other host device with modems and other peripherals. The serial bus may be operated in accordance with specifications and protocols defined by a standards body. In one example, the serial bus may be operated in accordance with I3C protocols that define timing relationships between signals and transmissions, which can enable devices limited to communicating in accordance with I2C protocols to coexist on a serial bus with devices that communicate in accordance with I3C protocols. Additionally, I2C and I3C peripherals may have dedicated hardware reset inputs to permit a master device to force a reset of a peripheral. A forced reset by asserting a signal input to a processor may be referred to as a hard reset. A peripheral device is typically not required to take any action to initiate a hard reset. Peripheral devices generally cannot block, gate or otherwise prevent assertion and/or execution of the hard reset. A soft reset may be initiated by a peripheral device in response to a command issued by a local processing circuit and/or received over the serial bus. In one example, a hard reset may be required if a peripheral becomes unresponsive. When the peripheral becomes non-responsive, it can be expected that issuing a soft reset would have no effect on the peripheral.

Certain aspects disclosed herein provide techniques for triggering a hard reset at peripheral devices using combinations of signaling over a serial bus. The signaling may cause an always-on circuit to trigger the hard reset without intervention or assistance of a local processing circuit in the peripheral device, such as a general-purpose processor, a controller, sequencer, a state machine, or combinational logic. The serial bus may be configured to operate in accordance with an I2C protocol, an I3C protocol, an SMBus protocol and/or an SPI protocol. This disclosure employs the example of an I3C bus to describe certain principles, aspects and that are applicable to implementations of a serial bus that operates according to I2C, SMBus, and/or SPI protocols. For example, certain of the signaling patterns described as being ignored by protocol processors in an I2C and/or I3C slave device may also be ignored by slave devices that are operated in accordance with SMBus or SPI protocols.

### Example Of An Apparatus With A Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

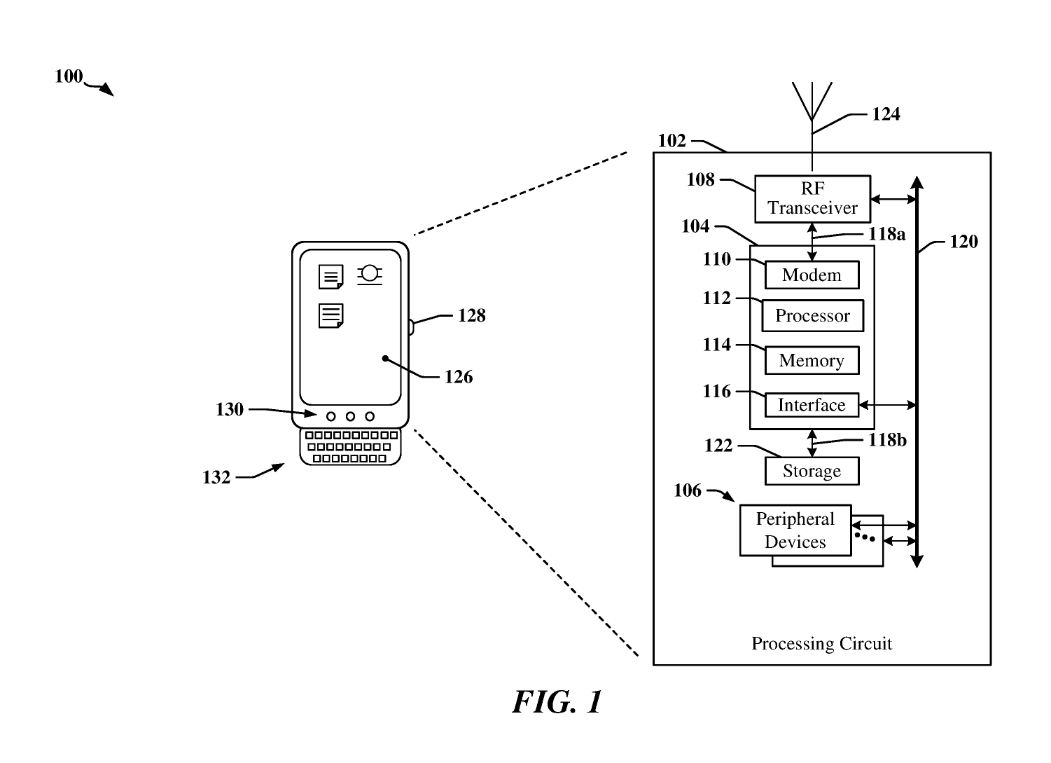

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

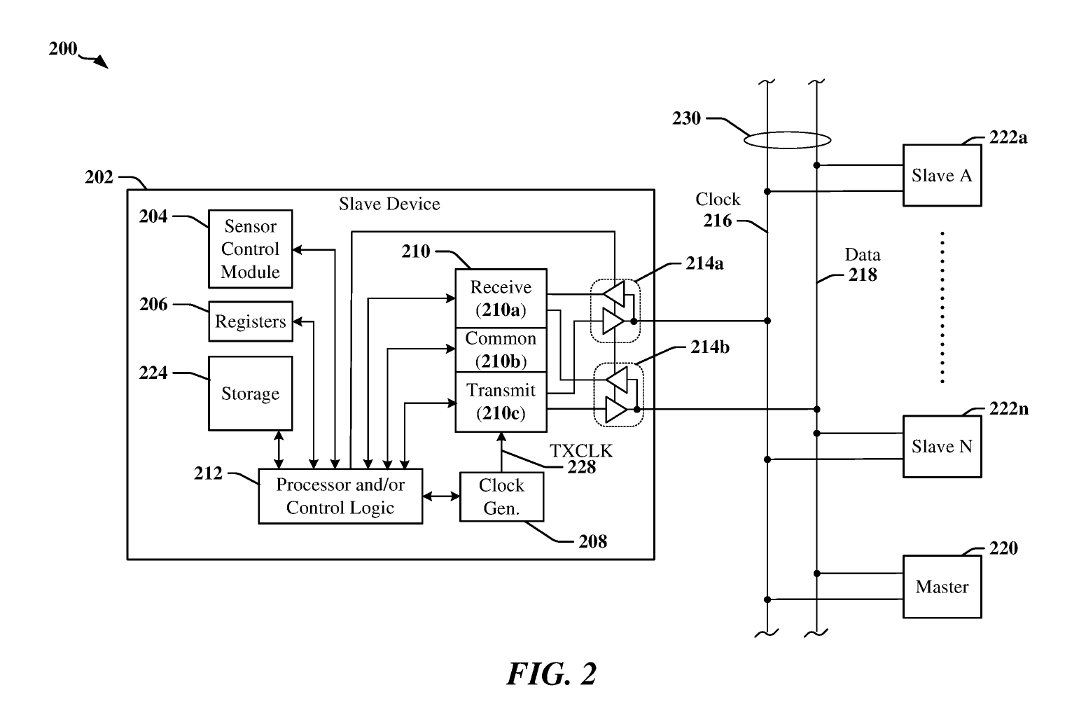

FIG. 2 illustrates certain aspects of an apparatus 200 that includes multiple devices 202, 220 and 222a-222n connected to a serial bus 230. The serial bus 230 may include a first wire 216 that carries a clock signal in certain I2C modes of operation while a second wire 218 carries a data signal. In other modes of operation, data may be encoded in multi-bit symbols, where each bit of the symbol controls signaling state of one of the wires 216, 218. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master 220. Certain types of bus can support multiple bus masters 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a sensor control function 204. The sensor control function 204 may include circuits and modules that support an image sensor, and/or circuits and modules that control and communicate with one or more sensors that measure environmental conditions. The slave device 202 may include configuration registers 206 or other storage 224, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing provided by a clock generation circuit 208.

Two or more of the devices 202, 220 and/or 222a-222n may be adapted according to certain aspects and features disclosed herein to support a plurality of different communication protocols over a common bus, which may include an SMBus protocol, an SPI protocol, an I2C protocol, and/or an I3C protocol. In some examples, devices that communicate using one protocol (e.g., an I2C protocol) can coexist on the same serial bus with devices that communicate using a second protocol (e.g., an I3C protocol). In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals transmitted on the serial bus 230.

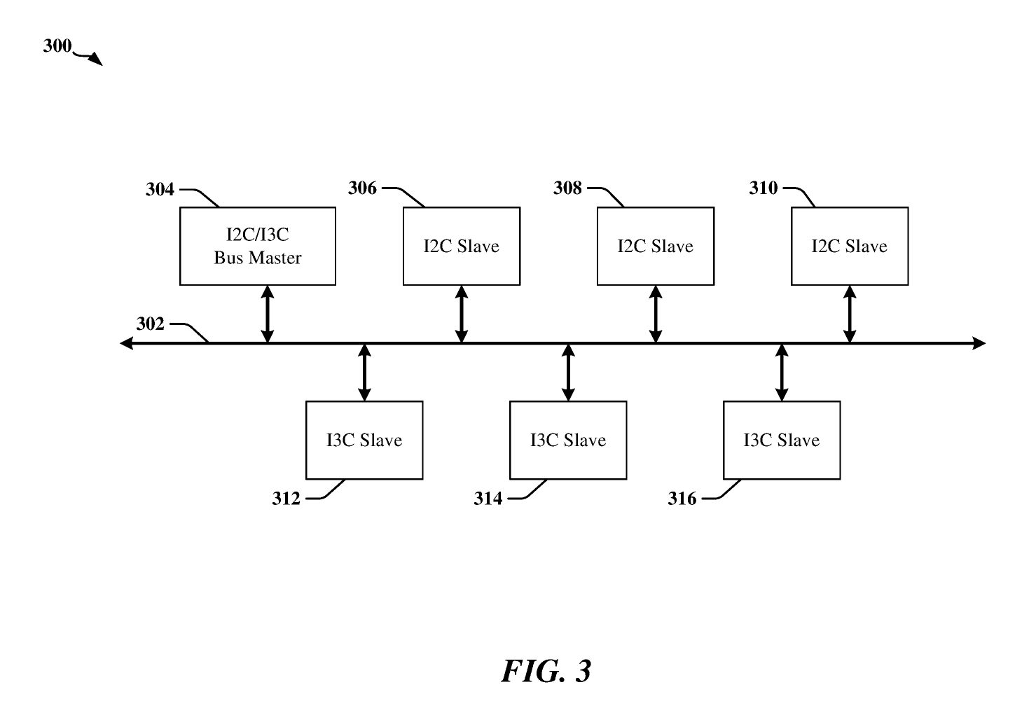

FIG. 3 illustrates a communication link 300 in which a configuration of devices 304, 306, 308, 310, 312, 314 and 316 are connected to a serial bus 302, whereby I3C devices 304, 312, 314 and 316 may be adapted or configured to obtain higher data transfer rates over the serial bus 302 using I3C protocols. The I3C devices 304, 312, 314 and 316 may coexist with conventionally configured I2C devices 306, 308, and 310. The I3C devices 304, 312, 314 and 316 may alternatively or additionally communicate using conventional I2C protocols, as desired or needed.

The serial bus 302 may be operated at higher data transfer rates when a master device 304 operates as an I3C bus master when controlling the serial bus 302. In the depicted example, a single master device 304 may serve as a bus master in I2C mode and in an I3C mode that supports a data transfer rate that exceeds the data transfer rate achieved when the serial bus 302 is operated according to a conventional I2C protocol. The signaling used for higher data-rate traffic may take advantage of certain features of I2C protocols such that the higher data-rate traffic can be carried over the serial bus 302 without compromising the functionality of legacy I2C devices 306, 308, 310 and 312 coupled to the serial bus 302.

### Timing In An I2C Bus

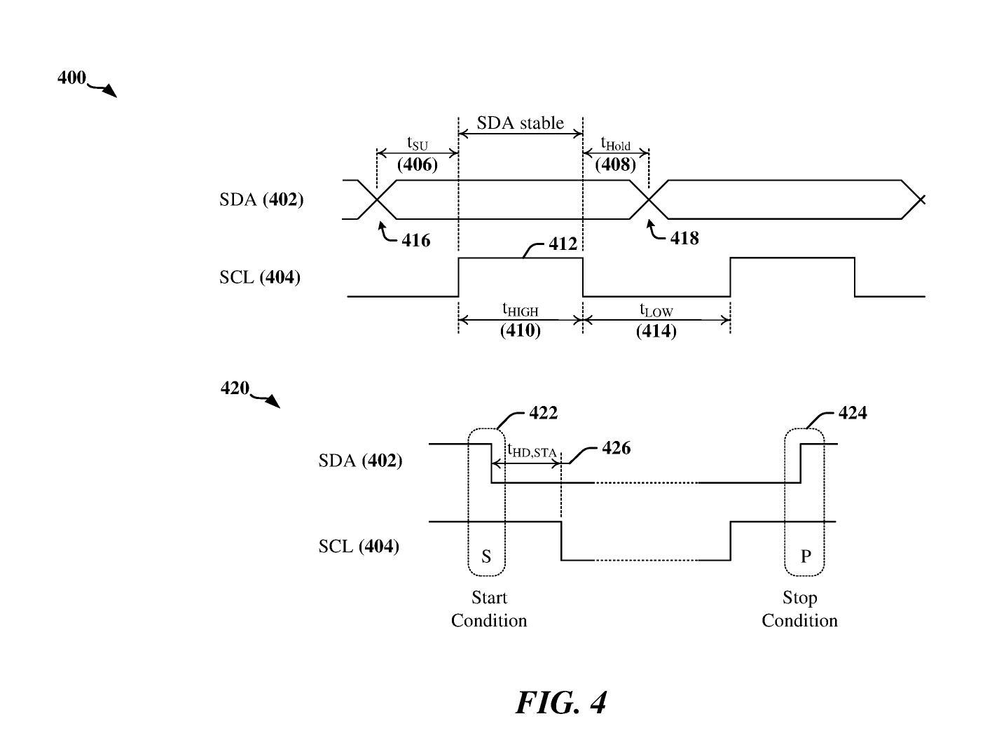

FIG. 4 includes timing diagrams 400 and 420 that illustrate the relationship between the SDA wire 402 and the SCL wire 404 on a conventional I2C bus. The first timing diagram 400 illustrates the timing relationship between the SDA wire 402 and the SCL wire 404 while data is being transferred on the conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid; the state of the SDA wire 402 is not permitted to change when the SCL wire 404 is in the high logic state.

Specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (t_{SU}) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

The second timing diagram 420 of FIG. 4 illustrates signaling states on the SDA wire 402 and the SCL wire 404 between data transmissions on a conventional I2C bus. The I2C protocol provides for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

A START condition 422 is defined to permit the current bus master to signal that data is to be transmitted. The START condition 422 occurs when the SDA wire 402 transitions from high to low while the SCL wire 404 is high. The I2C bus master initially transmits the START condition 422, which may be also be referred to as a start bit, followed by a 7-bit address of an I2C slave device with which it wishes to exchange data. The address is followed by a single bit that indicates whether a read or write operation is to occur. The addressed I2C slave device, if available, responds with an ACK bit. If no I2C slave device responds, the I2C bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a STOP condition 424 is transmitted by the I2C master device. The STOP condition 424 occurs when the SDA wire 402 transitions from low to high while the SCL wire 404 is high. The I2C Specifications require that all transitions of the SDA wire 402 occur when the SCL wire 404 is low, and exceptions may be treated as a START condition 422 or a STOP condition 424.

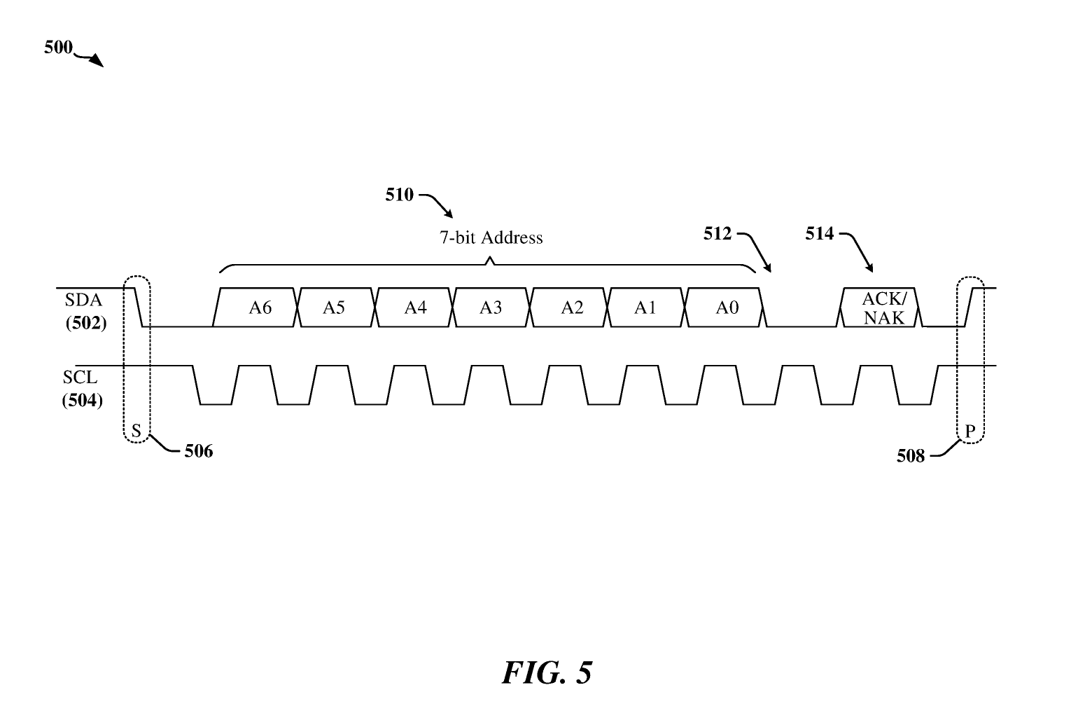

FIG. 5 is a diagram 500 that illustrates an example of the timing associated with a command word sent to a slave device in accordance with I2C protocols. In the example, a master device initiates the transaction with a START condition 506, whereby the SDA wire 502 is driven from high to low while the SCL wire remains high. The master device then transmits a clock signal on the SCL wire 504. The seven-bit address 510 of a slave device is then transmitted on the SDA wire 502. The seven-bit address 510 is followed by a Write/Read command bit 512, which indicates “Write” when low and “Read” when high. The slave device may respond in the next clock interval 514 with an acknowledgment (ACK) by driving the SDA wire 502 low. If the slave device does not respond, the SDA wire 502 is pulled high and the master device treats the lack of response as a NACK. The master device may terminate the transaction with a STOP condition 508 by driving the SDA wire 502 from low to high while the SCL wire 504 is high. This transaction can be used to determine whether a slave device with the transmitted address coupled to the I2C bus is in an active state.

The master device relinquishes control of the SDA wire 502 after transmitting the Write/Read command bit 512 such that the slave device may transmit an acknowledgment (ACK) bit on the SDA wire 502. In some implementations, open-drain drivers are used to drive the SDA wire 502. When open-drain drivers are used, the SDA drivers in the master device and the slave device may be active concurrently.

### Reset Mechanisms For A Serial Bus

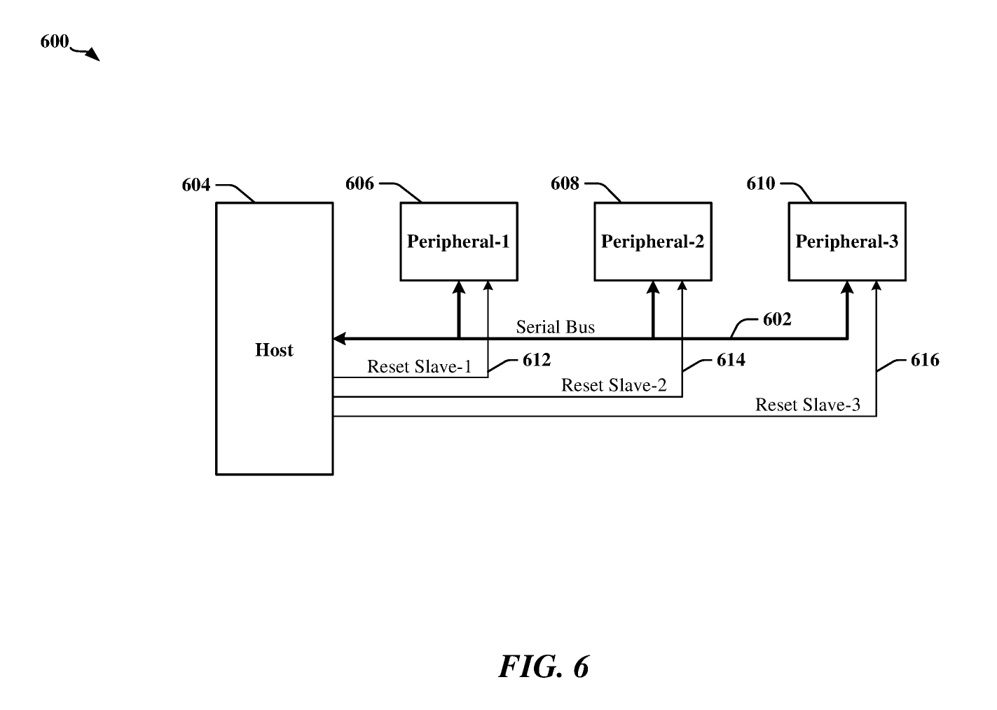

FIG. 6 illustrates an example of a system 600 that provides for hard reset of a plurality of peripherals 606, 608, 610 coupled to a serial bus 602. Conventionally, I2C an I3C peripherals 606, 608, 610 have dedicated hardware reset inputs to permit the peripherals 606, 608, 610 to be reset. For example, a hard reset may be required for one peripheral 606, 608 or 610 that becomes unresponsive, while reset of other peripherals 606, 608 and/or 610 may be undesirable. Accordingly, a conventional host device 604 must reserve a large number of pins to communicate individual reset signals 612, 614, 616 to each peripheral 606, 608, 610.

Certain aspects disclosed herein permit the elimination of some or all of the reset signals 612, 614, 616 provided to the peripherals 606, 608, 610. In one aspect, the peripherals 606, 608, 610 may be adapted to support an in-band reset that provides an effective hard reset capability without the need for dedicated reset signals 612, 614, 616.

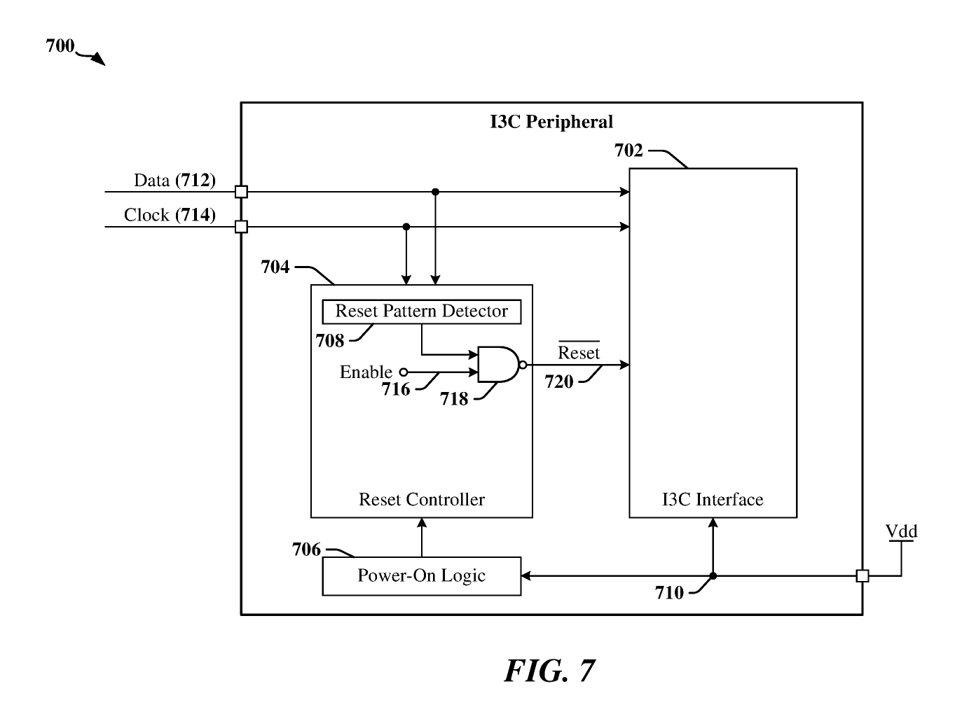

FIG. 7 illustrates a peripheral device 700 that has been adapted in accordance with aspects disclosed herein. The illustrated peripheral device 700 may be configured to operate according to I3C protocols. The peripheral device 700 may additionally or alternatively be configured to operate according to an I2C protocol, an SMBus protocol, an SPI protocol or another protocol that can be used with a serial bus. The serial bus may carry a data signal over a data line 712 and a clock signal over a clock line 714 when operated in certain I3C modes of operation and/or in I2C modes of operation. The data line 712 and clock line 714 may be repurposed to carry data symbols in signaling transmitted on both the data line 712 and clock line 714.

The peripheral device 700 includes an autonomous reset controller 704 that can produce a reset signal 720 while operating independently of the I3C interface 702 (or another type of interface), and/or a processing circuit in the peripheral device 700. The reset controller 704 may include a reset pattern detector 708 configured to generate a physical reset signal 720 when certain signaling patterns are detected on the data line 712 and/or clock line 714. The signaling patterns recognized by the reset pattern detector 708 are transmitted as in-band reset signals by a master device. An in-band reset signal may be implemented by transmitting a unique signaling combination that does not match any other clock and data signaling combination transmitted on the data line 712 and/or clock line 714 during normal operation of a serial bus.

The reset controller 704 may be implemented in a peripheral device 700 deployed in a peer-to-peer environment, where a pair of devices communicate over a serial bus. The reset controller 704 may also be implemented in a peripheral device 700 deployed in a multi-peripheral environment where a reset pattern may cause more than one peripheral to be reset.

In some implementations, gating logic 718 (here, a NAND gate) may be provided to enable selective generation of the reset signal 720. The ability to selectively generate the reset signal 720 may be provided to implement a reset addressing scheme in accordance with certain aspects disclosed herein. In one example, a reset enable signal 716 may be configured by the reset pattern detector 708 during normal operation. The reset enable signal 716 may be cleared or initialized during device power-on or power-cycle. Power-on logic 706 may monitor a power supply 710 of the peripheral device 700 to configure an initial signaling state of the reset enable signal 716, and clear the reset pattern detector 708, and/or other circuits in the reset controller 704.

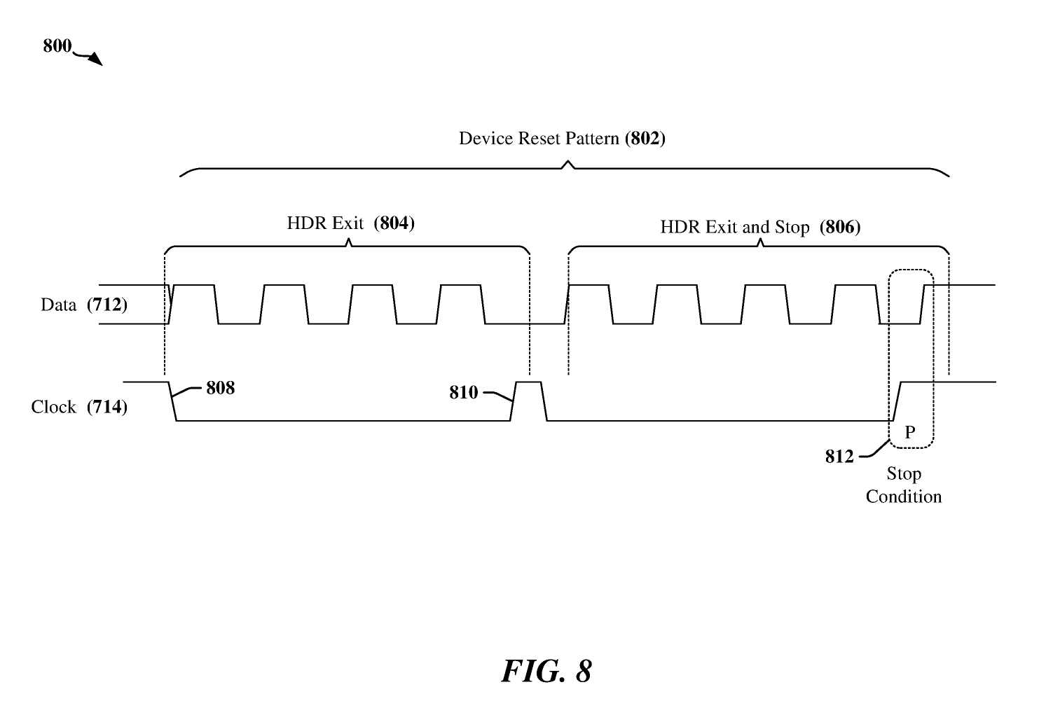

FIG. 8 illustrates an example of signaling 800 transmitted on the data line 712 and clock line 714 that may be recognized as a device reset pattern 802 by the reset pattern detector 708. In this example, the device reset pattern 802 includes a combination of signaling defined by I3C protocols that is, in effect, ignored by I3C protocol processors, or processing circuits that implement another protocol that can transmit or receive signals on the data line 712 and/or clock line 714. In systems that include devices that communicate using a combination of I2C and I3C protocols, I3C signaling is ignored by I2C devices by design. In some implementations, different patterns may be used to accomplish hard reset over an I3C bus while complying with I3C protocols and without affecting the operation of I2C devices.

The device reset pattern 802 includes two patterns 804, 806 that are defined by I3C protocols for use when devices coupled to an I3C bus can support two or more modes of communication and/or two or more I3C compliant protocols. I3C protocols define signaling that may be used to switch between modes of communication and/or to initiate communication according to one of a plurality of available I3C protocols. The two patterns 804, 806 in the exemplified device reset pattern 802 are defined by I3C protocols for use in initiating restart, exit and/or break from I3C high data rate (HDR) modes of communication. The patterns 804, 806 are not ordinarily concatenated in normal I3C transmissions, and combination of the patterns 804, 806 provides a unique I3C signaling pattern on the data line 712 and clock line 714 that is ignored by I2C devices and that at least partially initializes a signaling state of any I3C device that does not recognize the device reset pattern 802. The device reset pattern 802 illustrated here is but one example of many possible reset patterns. Various other viable signaling patterns are contemplated for use as a device reset pattern. A viable signaling patterns used as a device reset pattern may be configured based on the protocols used by devices coupled to a serial bus, including SMBus, SPI or other protocols that can be used with a serial bus.

The device reset pattern 802 includes a first pattern 804 that may be used to cause an HDR break or exit. The first pattern 804 commences with a falling edge 808 on the clock line 714 and ends with a rising edge 810 on the clock line 714. While the clock line 714 is in low signaling state, four pulses are transmitted on the data line 712. I2C devices ignore the data line 712 when no pulses are provided on the clock line 714. I3C devices may recognize the first pattern 804 as an HDR Exit pattern. I3C devices may be expected to exit active modes of communication when the first pattern 804 is received.

The second pattern 806 occurs at the rising edge of a pulse on the clock line 714 while the clock line 714 remains in the low signaling state. While the clock line 714 is in the low signaling state, four pulses are transmitted on the data line 712. The second pattern 806 terminates with a stop condition 812 (see also FIG. 4). I2C devices ignore the data line 712 when no pulses are provided on the clock line 714. The I2C devices are expected to reset their interfaces upon receipt of the stop condition 812. I3C devices may recognize the second pattern 804 as an HDR Exit and Stop pattern. I3C devices may be expected to exit active modes of communication and return to an initial protocol state when the second pattern 806 is received. I3C devices adapted to have the reset pattern detector 708 may generate a physical reset signal 720 when the device reset pattern 802 is detected on the data line 712 and/or clock line 714.

In some instances, an addressable in-band reset can be implemented such that a device reset pattern 802 may be ignored by peripheral devices other than certain peripheral devices selected by a host or master device for reset.

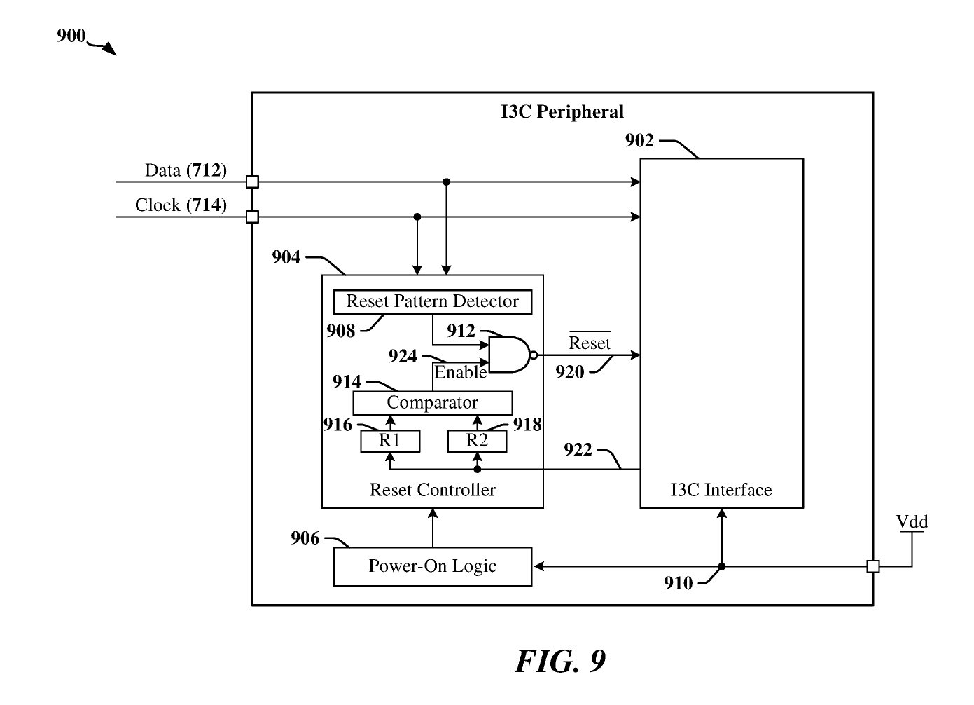

FIG. 9 illustrates a first example of a peripheral device 900 adapted to support targeted hard reset by a host device in accordance with certain aspects disclosed herein. The illustrated peripheral device 900 may be configured to operate according to I3C protocols. The peripheral device 900 may additionally or alternatively be configured to operate according to I2C protocols, or another protocol that can be used with a serial bus. The serial bus may carry a data signal over a data line 712 and a clock signal over a clock line 714 when operated in certain I3C modes of operation and/or in I2C modes of operation. The data line 712 and clock line 714 may be repurposed to carry data symbols in signaling transmitted on both the data line 712 and clock line 714.

The peripheral device 900 includes an autonomous reset controller 904 that can produce a reset signal 920 while operating independently of the I3C interface 902 and/or a processing circuit in the peripheral device 900. In various examples, the I3C interface 902 and/or processing circuit may be implemented using a state machine, sequencer, signal processor and/or general-purpose processor. The reset controller 904 may include a reset pattern detector 908 configured to generate a physical reset signal 920 when certain signaling patterns are detected on the data line 712 and/or clock line 714. In one example, the device reset pattern 802 of FIG. 8 may be recognized by the reset controller 904 as an in-band reset signal transmitted by a host or master device.

Gating logic 912 (here, a NAND gate) may be provided to enable selective generation of the reset signal 920. The ability to selectively generate the reset signal 920 may be used in implementing a reset addressing scheme in accordance with certain aspects disclosed herein. In the illustrated example, the reset signal 920 may be enabled based on the signaling state of an enable signal 924 indicative of the result of a comparison of content of two or more registers 916, 918. Comparison logic 914 may be adapted to compare, contrast, gate or otherwise perform a logic function or calculation on the two or more registers 916, 918 to determine the signaling state of the enable signal 924. The two or more registers 916, 918 may be configured through an internal bus or connection 922 by the I3C interface 902 and/or a processing circuit in the peripheral device 900. The two or more registers 916, 918 may be set to an initial condition after a power-on event detected by power-on logic 906, which typically monitors at least the power supply 910 of the peripheral device 900.

In some examples, the power-on logic 906 may cause the first register 916, which may be referred to as a Reset-ID Register (RIR), to be loaded with the device address of the peripheral device 900 after the power-on event. The power-on logic 906 may cause the second register 918, which may be referred to as a Reset-Gating Register (RGR), to be loaded with a value that is different from the device address of the peripheral device 900. When more than one RGR is provided (i.e., RGR₁ . . . RGR_{N}), the power-on logic 906 may initialize one or more of the RGR registers to have a value that is different from the device address of the peripheral device 900. In one example, the power-on logic 906 may cause the RIR and at least one RGR to be loaded with values that have different least significant bit (LSBs) after the power-on event. That is, the LSB of the RIR is the reverse of the LSB of at least one RGR.

Other approaches to ensuring a difference between the RIR and at least one RGR may be adopted. For example, the power-on logic 906 may cause the RIR to be loaded with the device address of the peripheral device 900 after the power-on event. A first RGR (RGR₁) may be configured with a first nibble of the device address of the peripheral device 900 reversed, while a second RGR (RGR₂) may be configured with a second, different nibble of the device address of the peripheral device 900 reversed. The different values in RGR₁ and RGR₂ can ensure that the reset signal 920 is generated when a device reset pattern 802 is detected. In normal operation, the reset signal 920 may be suppressed by writing the device address of the peripheral device 900 into both RGR₁ and RGR₂.

In some implementations, the reset controller 904 may be adapted or configured to autonomously modify one or more RGRs after a device reset pattern 802 is detected while generation of the reset signal 920 has been suppressed. For example, a master device may configure the RGRs in the reset controller 904 to have the same address as the RIR in order to suppress generation of the reset signal 920. In a two-register example, the master device may cause the first register 916 and the second register 918 to have the same value before transmitting the device reset pattern 802. The peripheral device 900 ignores the device reset pattern 802. After a fixed time delay, the reset controller 904 may reconfigure the first register 916 and the second register 918 to have different values. The fixed time delay may be measured from the device reset pattern 802, and/or from the time when the first register 916 and the second register 918 are configured with the same value. The fixed time delay may be implemented as a watchdog timer that reconfigures the first register 916 and the second register 918 after the fixed period of time unless an affirmative action or set of actions defers the reconfiguring of the registers 916, 918 to cause the reset controller 904 to trigger a reset signal 920 upon detection of a device reset pattern 802.

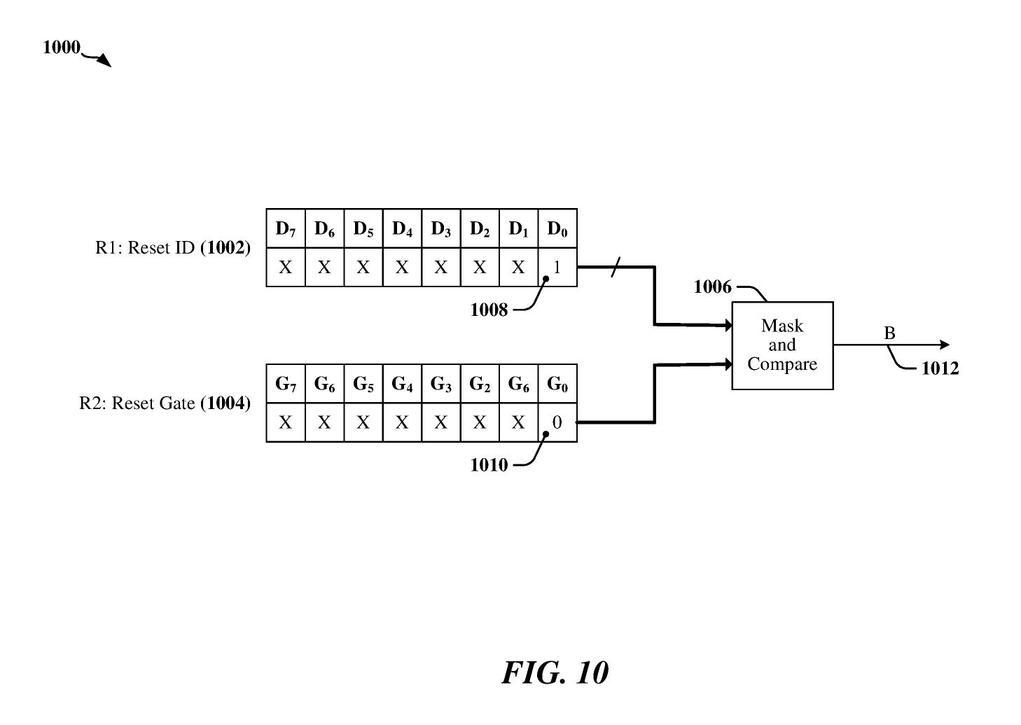

FIG. 10 illustrates one example 1000 of a configuration of two registers 1002, 1004 used to enable selective or targeted generation of the reset signal 920. In this example, the comparison logic 914 includes a mask and compare logic circuit 1006 that performs a comparison of a certain number of bits in the registers 1002, 1004. After power-on, for example, the mask and compare logic circuit 1006 may be initialized to compare a single bit 1008, 1010 in each register 1002, 1004 and generate an enable signal (output B 1012) based on the comparison. In the example 1000, a first register (Reset ID register 1002) may be configured to have at least one bit 1008 set to ‘1’ after a power-on event, and a second register (Reset Gate register 1004) may be configured to have a corresponding bit 1010 set to ‘0’ after the power-on event. The mask and compare logic circuit 1006 may be configured to assert a True condition in output B 1012 such that any transmission of the device reset pattern 802 results in an assertion of the reset signal 920. The I3C interface 902 and/or a processing circuit in the peripheral device 900 may be configured to write values into the Reset ID register 1002, the Reset Gate register 1004 and/or a mask or other register. A host or master device may reset devices selected based on the values written to the Reset ID register 1002, the Reset Gate register 1004, or the mask.

In one example, the Reset ID register 1002, the Reset Gate register 1004 may be implemented as 8-bit flops. The output B 1012 may be provided as the enable signal 924 in the peripheral device 900 of FIG. 9. At an initial power-on event the least significant bit of the Reset ID register 1002 is configured with the value D₀=1 and the least significant bit of the Reset Gate register 1004 is configured with the value G₀=0. The output of the mask and compare logic circuit 1006 may be defined as follows:
B=“1” when Val(D₀)!=Val(G₀)
B=“0” when Val(D₀)=Val(G₀)

The Reset ID register 1002 and the Reset Gate register 1004 may be addressable by the host or master device through an available or enabled serial interface. The host or master device may write different values to the Reset ID register 1002 and the Reset Gate register 1004 of any peripheral to be reset through transmission of the device reset pattern 802. The host or master device may write the same value to the Reset ID register 1002 and the Reset Gate register 1004 of any peripheral that is to ignore a transmission of the device reset pattern 802. In one example, the host or master device may broadcast equal values for the Reset ID register 1002 and the Reset Gate register 1004 to all peripherals, and then write different values to the Reset ID register 1002 and the Reset Gate register 1004 of any peripheral to be reset before transmitting the device reset pattern 802.

In some instances, the Reset ID register 1002 and the Reset Gate register 1004 of each peripheral may be configured to ensure that a reset can be triggered by the device reset pattern 802, even if the peripheral device 900 becomes non-responsive.

It is contemplated that different configurations of the Reset ID register 1002, the Reset Gate register 1004 and the mask and compare logic circuit 1006 may be implemented based on application. For example, mask and compare logic circuit 1006 may be configured to enable a reset in response to the device reset pattern 802 if the values of the Reset ID register 1002 and the Reset Gate register 1004 match. The Reset ID register 1002 of each peripheral device 900 may be programmed with a value that is unique to the peripheral device 900 or shared with a limited number of other peripheral devices. A host or master device may write the address of a targeted peripheral device 900 (or group of devices) into the Reset Gate register 1004 of all peripheral devices 900 by broadcast write command, or by individual write commands, before transmitting the device reset pattern 802.

The latter example may be applicable when some degree of cooperation is available from the peripheral device 900 in order to successfully modify values in the Reset ID register 1002 and/or the Reset Gate register 1004. Certain aspects disclosed herein provide addressability of the reset controller 904 with minimal or no intervention or participation by processing circuits in the peripheral device 900.

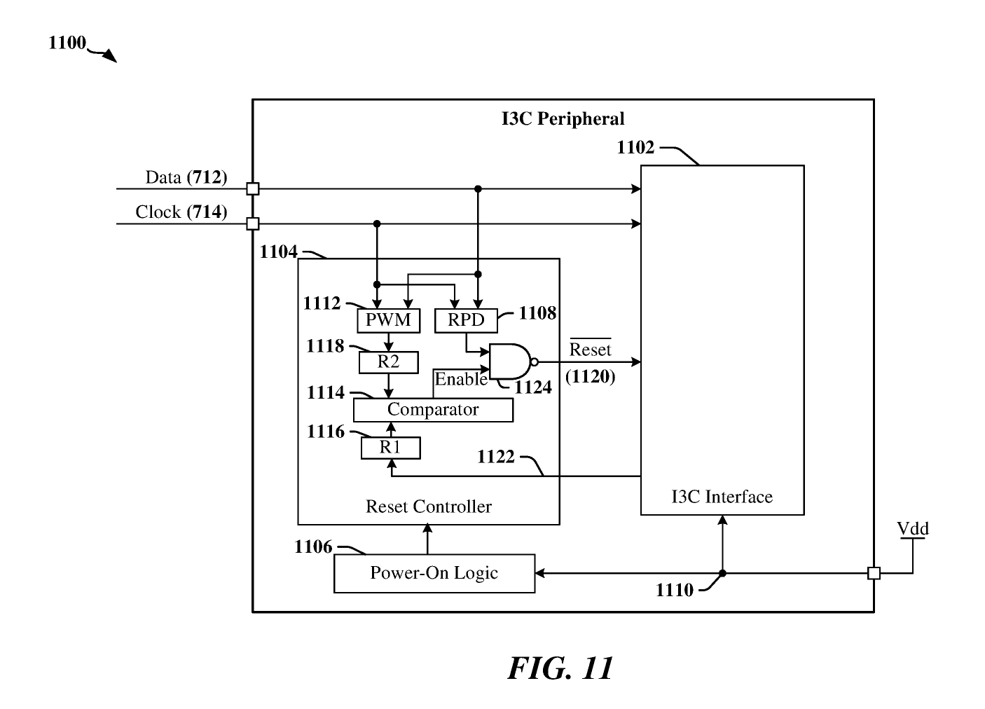

FIG. 11 illustrates a second example of a peripheral device 1100 adapted in accordance with certain aspects disclosed herein to support targeted hard reset initiated by a host device. In this example, a reset controller 1104 includes a register that may be programmed using information encoded in signals received from the data line 712 and/or the clock line 714 of a serial bus. The illustrated peripheral device 1100 may be configured to operate according to I3C protocols. The peripheral device 1100 may additionally or alternatively be configured to operate according to I2C protocols or another protocol that can be used with a serial bus. The serial bus may carry a data signal over a data line 712 and a clock signal over a clock line 714 when operated in certain I3C modes of operation and/or in various I2C modes of operation. In some modes of operation, the data line 712 and clock line 714 may be repurposed to carry data symbols in signaling transmitted on both the data line 712 and clock line 714 in accordance with an I3C protocol, a proprietary protocol or another protocol.

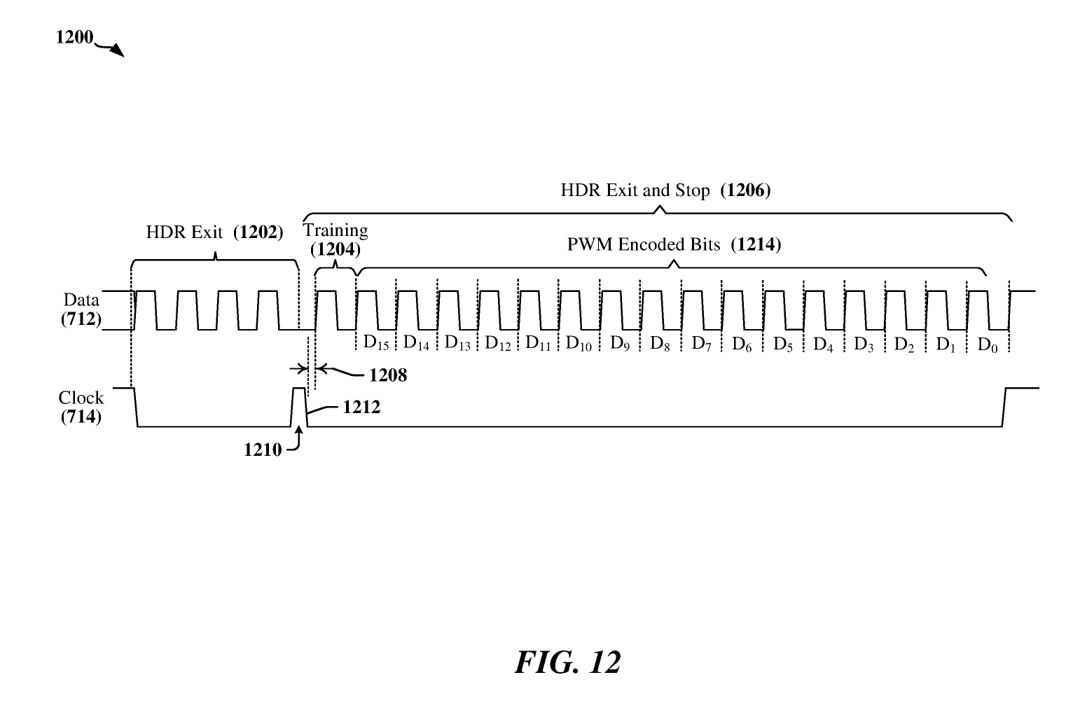

The peripheral device 1100 includes an autonomous reset controller 1104 that can produce a reset signal 1120 while operating independently of the I3C interface 1102 and/or a processing circuit in the peripheral device 1100. The reset controller 1104 may be initialized to an initial condition after a power-on event has been detected by power-on logic 1106, which typically monitors at least the power supply 1110 of the peripheral device 1100. The reset controller 1104 may include a reset pattern detector 1108 configured to generate a physical reset signal 1120 when certain signaling patterns are detected on the data line 712 and/or clock line 714. FIG. 12 illustrates an example of a targeted device reset pattern 1200 that may be recognized by the reset controller 1104 as an in-band reset signal transmitted by a host or master device.

The targeted device reset pattern 1200 may be based on the device reset pattern 802 of FIG. 8. For example, the targeted device reset pattern 1200 may include a first pattern 1202 that corresponds to the same I3C HDR break or exit pattern provided in the first pattern 804 of the device reset pattern 802 in FIG. 8. The targeted device reset pattern 1200 may include a second pattern 1206 that is an elongated version of I3C HDR exit and stop pattern provided in the second pattern 806 of the device reset pattern 802 in FIG. 8.

According to certain aspects disclosed herein, information may be encoded in the targeted device reset pattern 1200 using pulse width modulation (PWM). The information may include address information used to select a peripheral device 1100 for reset. In some examples, information encoded in the targeted device reset pattern 1200 may determine a type of reset, hibernation, wakeup, interrupt or other aspect of control that may be asserted over the peripheral device 1100, regardless of whether the peripheral device 1100 is otherwise responsive or unresponsive.

The peripheral device 1100 may include a PWM decoder 1112 that is configured to decode information transmitted in the targeted device reset pattern 1200. In some examples, the PWM decoder 1112 may be enabled after detection of the first pattern 1202. Pulses in the first pattern 1202 may be used to train the PWM decoder 1112. Alternatively, or additionally, one or more initial pulses 1204 transmitted in the second pattern 1206 may be used to train the PWM decoder 1112. The PWM decoder 1112 may be trained by providing pulses with a 50% duty cycle. In some examples, data decoded by the PWM decoder 1112 from the second pattern 1206 may be transferred to a register (PWM register 1118) upon termination of a valid second pattern 1206.

In some implementations, comparison logic 1114 may be adapted to generate the reset signal 1120 based on a comparison, contrast, gating or other logic function or calculation performed using the PWM register 1118 and another peripheral or host configured register (the R1 register 1116). In some examples, the R1 register 1116 can be configured through an internal bus or connection 1122 by the I3C interface 1102 and/or a processing circuit in the peripheral device 1100. In various examples, the processing circuit may be implemented using a state machine, sequencer, signal processor and/or general-purpose processor. In some examples, the R1 register 1116 may be configured with a unique device identifier, or a unique device reset identifier that is used for autonomous reset of the peripheral device 1100. In one mode of operation, a host or master device may use PWM to encode an identifier corresponding to a targeted peripheral device 1100 in the second pattern 1206. Gating logic 1124 (here, a NAND gate) provided in the reset controller 1104 of the targeted peripheral device 1100 may be enabled when the comparison logic 1114 recognizes a correspondence between the content of the PWM register 1118 and the R1 register 1116. In one example, the reset signal 1120 may be asserted when the reset pattern detector 1108 determines that a valid targeted device reset pattern 1200 has been received and the values of the PWM register 1118 matches the value of the R1 register 1116. In some examples, the determination of a match between the PWM register 1118 and the R1 register 1116 is made after masking certain bits of the PWM register 1118 and/or the R1 register 1116.

In the example illustrated in FIG. 12, the targeted device reset pattern 1200 encodes a 16-bit PWM word 1214 in the second pattern 1206. A pulse 1210 provided on the clock line 714 may indicate the termination of the first pattern 1202. The occurrence of a falling edge 1212 of the pulse 1210 may indicate the commencement of the second pattern. The occurrence of the falling edge 1212 of the pulse 1210 may enable a reset operation at one or more peripheral devices 1100. When PWM encoding is used, the PWM decoder 1112 may be trained using one or more training pulses 1204, which may have a 50% duty cycle. The training pulses 1204 may be transmitted after a delay 1208 provided to ensure stability of signaling prior to the transmission of the training pulses 1204. In one example, the delay may be configured to be a quarter-cycle of the transmitter clock signal. The targeted device reset pattern 1200, the first pattern 1202 and/or the second pattern 1206 may be transmitted using a transmitter clock of any desired frequency. In one example, a transmitting device may control data transmissions using a transmitter clock (cf. the TXCLK 228 in FIG. 2) that may have a lower frequency when used for a reset operation than when used for transmitting data in normal operations. A slower transmitter clock may promote more reliable communication of PWM encoded data.

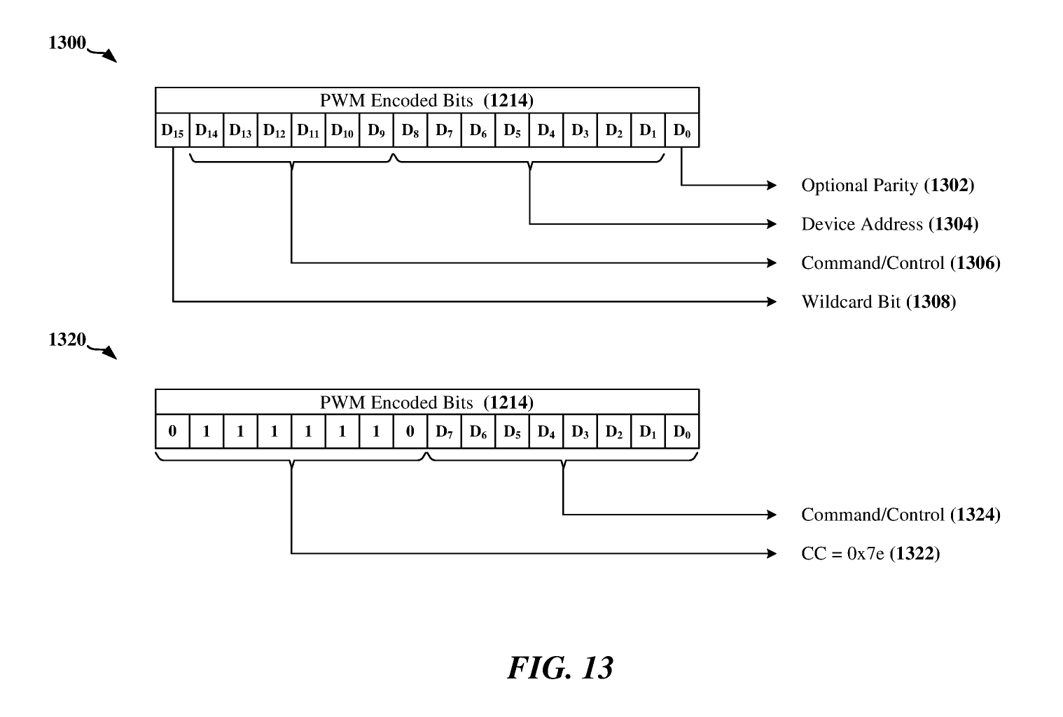

FIG. 13 illustrates examples of configurations 1300, 1320 of information that may be encoded in a PWM word 1214 provided in the second pattern 1206. In a first configuration 1300, the PWM word 1214 includes a parity bit 1302, a reset device address 1304, a command and/or control code 1306 and a wildcard bit 1308. Some of the fields 1302, 1304, 1306, 1308 may be optional. In one example, a parity bit 1302 may be omitted or ignored in some implementations. In another example, the command and/or control code 1306 may be omitted, ignored or reserved for use in certain applications. In some instances, the parity bit 1302 and/or the command and/or control code 1306 may be used as an extended address field, a mask field or for other addressing purposes. The reset device address 1304 may carry an identifier corresponding to a peripheral device 1100 to be reset. In one example, the identifier may be the unique identifier assigned to the peripheral device 1100 by protocol (e.g., by an I2C or I3C protocol). In another example, the identifier may be an identifier assigned to the peripheral device 1100 to support targeted reset operations. In another example, the identifier may be the group identifier assigned to a plurality of peripheral devices 1100 by protocol, or to support targeted reset operations. The wildcard bit 1308 may be used to indicate whether a reset operation is directed to a single peripheral device 1100 or to all peripheral devices 1100.

In a second configuration 1320, the PWM word 1214 includes a code 1322 that indicates that a command or control word 1324 follows. The command or control word may be decoded by the peripheral device 1100 to determine an action to be performed. The action may include or involve a reset operation, a power management operation or some other operation defined for an application that implements or supports the configuration 1320, the PWM word 1214.

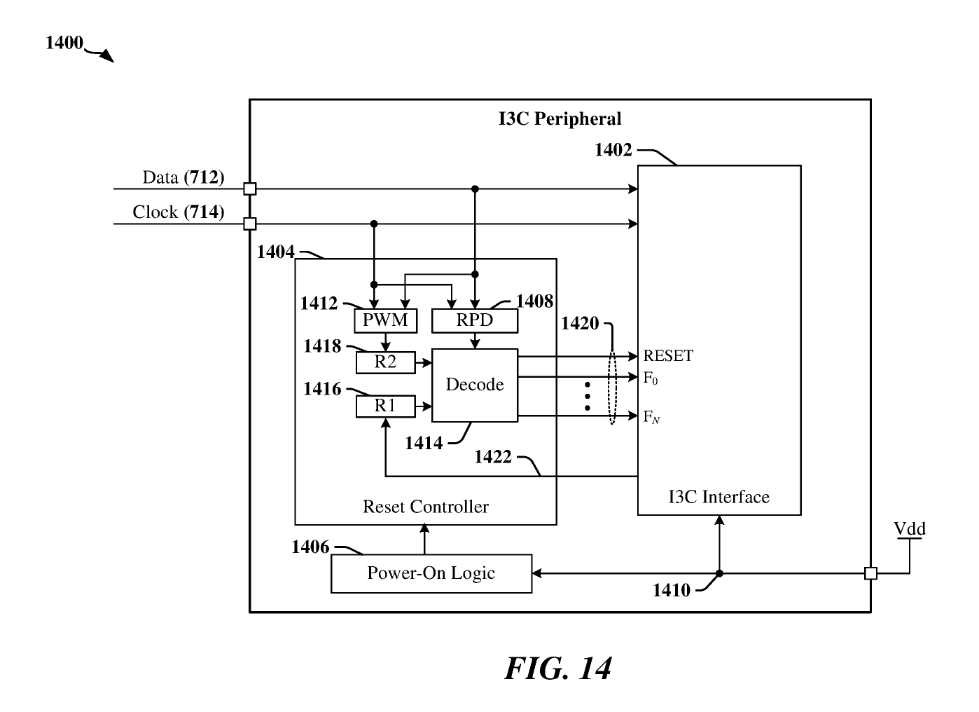

FIG. 14 illustrates a third example of a peripheral device 1400 adapted in accordance with certain aspects disclosed herein to support targeted hard reset initiated by a host device. In this example, a reset controller 1404 includes a register that may be programmed using information encoded in signals received from the data line 712 and/or the clock line 714 of a serial bus. The reset controller 1404 may be initialized to an initial condition after a power-on event has been detected by power-on logic 1406, which typically monitors at least the power supply 1410 of the peripheral device 1100. In some examples, the peripheral device 1400 may be configured to operate according to I3C protocols. The peripheral device 1400 may additionally or alternatively be configured to operate according to I2C protocols or another protocol that can be used with a serial bus. The serial bus may carry a data signal over a data line 712 and a clock signal over a clock line 714 when operated in certain I3C modes of operation and/or in various I2C modes of operation. In some modes of operation, the data line 712 and clock line 714 may be repurposed to carry data symbols in signaling transmitted on both the data line 712 and clock line 714 in accordance with an I3C protocol, a proprietary protocol or another protocol.

The peripheral device 1400 includes an autonomous reset controller 1404 that generates or manipulates one or more control signals 1420 coupled to a I3C interface 1402 and/or a processing circuit in the peripheral device 1400. In various examples, the processing circuit may be implemented using a state machine, sequencer, signal processor and/or general-purpose processor. In some examples, the control signals 1420 can include a reset signal, one or more interrupt signals, a sleep control signal, a power management signal and/or other signals that may control or influence the operation of the peripheral device 1400. In another example, the control signals 1420 may include some combination of a reset signal and a control word that may control or influence the operation of the peripheral device 1400.

The reset controller 1404 may include a reset pattern detector 1408 configured to detect certain signaling patterns are detected on the data line 712 and/or the clock line 714. The signaling patterns recognized by the reset pattern detector 1408 may include a device reset pattern 802 (see FIG. 8) and/or the targeted device reset pattern 1200 (see FIG. 12).

The peripheral device 1400 may include a PWM decoder 1412 that is configured to decode information transmitted in a targeted device reset pattern 1200. In some examples, the PWM decoder 1412 may be enabled after detection of the first pattern 1202. Pulses in the first pattern 1202 may be used to train the PWM decoder 1412. Alternatively, or additionally, one or more initial pulses 1204 transmitted in the second pattern 1206 may be used to train the PWM decoder 1412. The PWM decoder 1412 may be trained by providing pulses with a 50% duty cycle. In some examples, data decoded by the PWM decoder 1412 from the second pattern 1206 may be transferred to the register (PWM register 1418) upon termination of a valid second pattern 1206.

In some implementations, decode logic 1414 may be adapted to generate the control signals 1420 based on a comparison, contrast, gating or other logic function or calculation performed using information provided by the reset pattern detector 1408, the PWM register 1418 and/or a register (the R1 register 1416) programmed by the I3C interface 1402 or a processing circuit of the peripheral device 1400. In various examples, the processing circuit may be implemented using a state machine, sequencer, signal processor and/or general-purpose processor. In some examples, the R1 register 1416 can be configured through an internal bus or connection 1422 by the I3C interface 1402 and/or a processing circuit in the peripheral device 1400. In one example, the R1 register 1416 may be configured with a unique device identifier, or a unique device reset identifier that is used for autonomous reset of the peripheral device 1400. In one mode of operation, a host or master device may use PWM to encode an identifier corresponding to a targeted peripheral device 1400 in the second pattern 1206.

The decode logic 1414 may be configured to determine if the peripheral device 1400 is addressed in the targeted device reset pattern 1200. In one example, the peripheral device 1400 may be explicitly identified when the targeted device reset pattern 1200 includes a reset device address 1304 corresponding to the peripheral device 1400. In another example, the peripheral device 1400 may be implicitly identified when a wildcard bit 1308 in the targeted device reset pattern 1200 is configured to cause multiple devices to respond to the targeted device reset pattern 1200. In some examples, the peripheral device 1400 may respond to the targeted device reset pattern 1200 by asserting a reset signal, and/or one or more other control signals 1420. In one example, the other control signals 1420 may be asserted in response to a command or control word 1324 encoded in the targeted device reset pattern 1200.

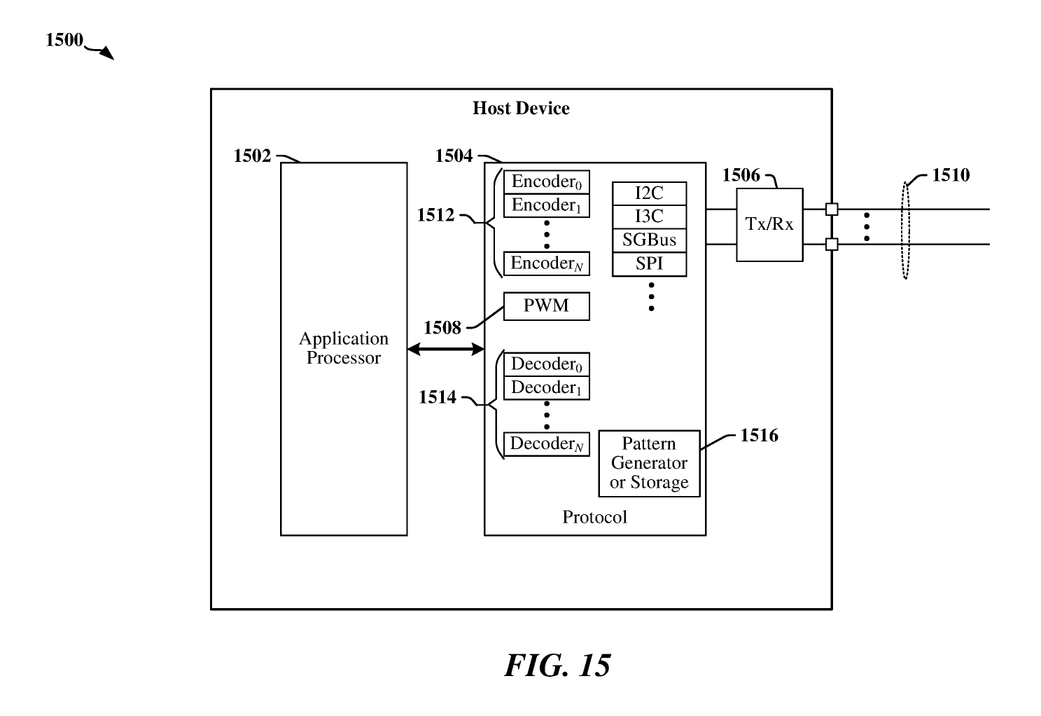

FIG. 15 illustrates a host device 1500 adapted to assert and support autonomous control over slave devices in accordance with certain aspects disclosed herein. The host device 1500 may include an application processor 1502, a general purpose, or another application-specific processor. Transmitter/Receiver circuits 1506 may provide line drivers, clock generators, receivers, and other circuits that can be configured to enable the host device 1500 to communicate over a multi-wire serial bus 1510. One or more protocol modules 1504 may be provided to support various communication protocols. The protocol modules 1504 may be implemented in hardware, software, and/or some combination of hardware and software. The protocol modules 1504 may be implemented as a separate device, or implemented in whole or in part within the application processor 1502. Each protocol module 1504 may include encoders 1512 and decoders 1514 configured to support communication protocols and standards. In various examples, the encoders 1512 and decoders 1514 may support some combination of I2C, I3C, SGBus and SPI protocols, among other protocols.

According to certain aspects, a protocol module 1504 may include a PWM encoder 1508 that may be used to encode information in signaling transmitted on the multi-wire serial bus 1510 in accordance with certain aspects disclosed herein. The protocol module 1504 may include a pattern generator or storage 1516 that generates and/or maintains signaling patterns in accordance with certain aspects disclosed herein. The protocol module 1504 may maintain information for generating patterns in the pattern generator or storage 1516.

### Examples of Processing Circuits and Methods

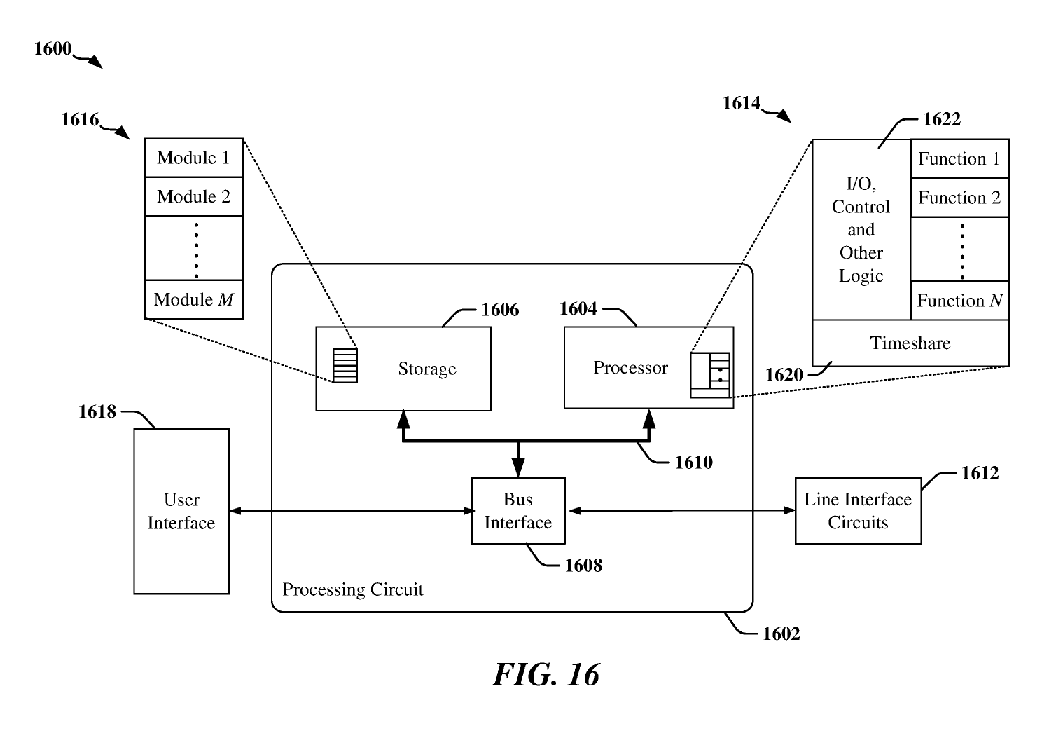

FIG. 16 is a diagram illustrating an example of a hardware implementation for an apparatus 1600 employing a processing circuit 1602 that may be configured to perform one or more functions disclosed herein. In accordance with various aspects of the disclosure, an element, or any portion of an element, or any combination of elements as disclosed herein may be implemented using the processing circuit 1602. The processing circuit 1602 may include one or more processors 1604 that are controlled by some combination of hardware and software modules. Examples of processors 1604 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1604 may include specialized processors that perform specific functions, and that may be configured, augmented or controlled by one of the software modules 1616. The one or more processors 1604 may be configured through a combination of software modules 1616 loaded during initialization, and further configured by loading or unloading one or more software modules 1616 during operation. In various examples, the processing circuit 1602 may be implemented using a state machine, sequencer, signal processor and/or general-purpose processor, or a combination of such devices and circuits.

In the illustrated example, the processing circuit 1602 may be implemented with a bus architecture, represented generally by the bus 1610. The bus 1610 may include any number of interconnecting buses and bridges depending on the specific application of the processing circuit 1602 and the overall design constraints. The bus 1610 links together various circuits including the one or more processors 1604, and storage 1606. Storage 1606 may include memory devices and mass storage devices, and may be referred to herein as computer-readable media and/or processor-readable media. The bus 1610 may also link various other circuits such as timing sources, timers, peripherals, voltage regulators, and power management circuits. A bus interface 1608 may provide an interface between the bus 1610 and one or more transceivers 1612. A transceiver 1612 may be provided for each networking technology supported by the processing circuit. In some instances, multiple networking technologies may share some or all of the circuitry or processing modules found in a transceiver 1612. Each transceiver 1612 provides a means for communicating with various other apparatus over a transmission medium. Depending upon the nature of the apparatus 1600, a user interface 1618 (e.g., keypad, display, speaker, microphone, joystick) may also be provided, and may be communicatively coupled to the bus 1610 directly or through the bus interface 1608.

A processor 1604 may be responsible for managing the bus 1610 and for general processing that may include the execution of software stored in a computer-readable medium that may include the storage 1606. In this respect, the processing circuit 1602, including the processor 1604, may be used to implement any of the methods, functions and techniques disclosed herein. The storage 1606 may be used for storing data that is manipulated by the processor 1604 when executing software, and the software may be configured to implement any one of the methods disclosed herein.

One or more processors 1604 in the processing circuit 1602 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1606 or in an external computer-readable medium. The external computer-readable medium and/or storage 1606 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1606 may also include, by way of example, a carrier wave, a transmission line, and any other suitable medium for transmitting software and/or instructions that may be accessed and read by a computer. Computer-readable medium and/or the storage 1606 may reside in the processing circuit 1602, in the processor 1604, external to the processing circuit 1602, or be distributed across multiple entities including the processing circuit 1602. The computer-readable medium and/or storage 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1606 may maintain software maintained and/or organized in loadable code segments, modules, applications, programs, etc., which may be referred to herein as software modules 1616. Each of the software modules 1616 may include instructions and data that, when installed or loaded on the processing circuit 1602 and executed by the one or more processors 1604, contribute to a run-time image 1614 that controls the operation of the one or more processors 1604. When executed, certain instructions may cause the processing circuit 1602 to perform functions in accordance with certain methods, algorithms and processes described herein.

Some of the software modules 1616 may be loaded during initialization of the processing circuit 1602, and these software modules 1616 may configure the processing circuit 1602 to enable performance of the various functions disclosed herein. For example, some software modules 1616 may configure internal devices and/or logic circuits 1622 of the processor 1604, and may manage access to external devices such as the transceiver 1612, the bus interface 1608, the user interface 1618, timers, mathematical coprocessors, and so on. The software modules 1616 may include a control program and/or an operating system that interacts with interrupt handlers and device drivers, and that controls access to various resources provided by the processing circuit 1602. The resources may include memory, processing time, access to the transceiver 1612, the user interface 1618, and so on.

One or more processors 1604 of the processing circuit 1602 may be multifunctional, whereby some of the software modules 1616 are loaded and configured to perform different functions or different instances of the same function. The one or more processors 1604 may additionally be adapted to manage background tasks initiated in response to inputs from the user interface 1618, the transceiver 1612, and device drivers, for example. To support the performance of multiple functions, the one or more processors 1604 may be configured to provide a multitasking environment, whereby each of a plurality of functions is implemented as a set of tasks serviced by the one or more processors 1604 as needed or desired. In one example, the multitasking environment may be implemented using a timesharing program 1620 that passes control of a processor 1604 between different tasks, whereby each task returns control of the one or more processors 1604 to the timesharing program 1620 upon completion of any outstanding operations and/or in response to an input such as an interrupt. When a task has control of the one or more processors 1604, the processing circuit is effectively specialized for the purposes addressed by the function associated with the controlling task. The timesharing program 1620 may include an operating system, a main loop that transfers control on a round-robin basis, a function that allocates control of the one or more processors 1604 in accordance with a prioritization of the functions, and/or an interrupt driven main loop that responds to external events by providing control of the one or more processors 1604 to a handling function.

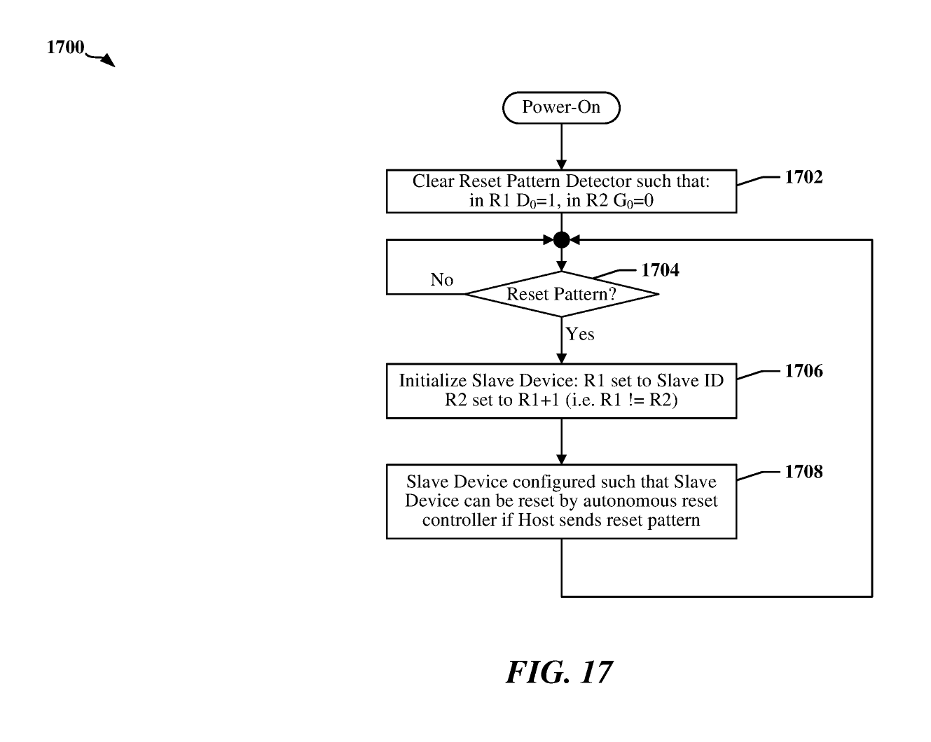

FIG. 17 is a flowchart 1700 illustrating the configuration of a slave device by a master device after a power-on event. The slave device may incorporate certain of the features of the peripheral device 900 illustrated in FIG. 9, for example. At block 1702, the slave device may emerge from a power-on event such as a power-on reset. In some examples, the registers 916, 918 of the slave device may be initialized to have different values.

After initialization, the reset controller 904 in the peripheral device 900 can operate autonomously of the I3C interface 902. At block 1704, the reset controller 904 may monitor the data line 712 and clock line 714 and may respond to the receipt and detection of a device reset pattern 802 by asserting a reset signal 920 to reset the I3C interface 902. At block 1706, the registers 916, 918 of the slave device may be reconfigured. The peripheral device 900 may configure the R1 register 916 with a device reset ID value and a gating value that is different from the device reset ID value. In one example, the gating value may be calculated as the device reset ID value incremented by 1. The peripheral device 900 may cooperate with the master device to configure the R1 register 916 when, for example, the master device writes the device reset ID value directly or indirectly. In one example, the master device may be able to directly address the R1 register 916. In another example, the master device may assign a slave identifier to the peripheral device 900, from which the device reset ID value may be derived.

At block 1708, the reset controller 904 may be configured to operate autonomously. The reset controller 904 may operate independently of the I3C interface 902 and other components of the peripheral device 900 when the R1 register 916 has a different value than the R2 register 918. The reset controller 904 can detect a device reset pattern 802 without further configuration by the master device. The reset controller 904 may return to block 1704 to await receipt of a device reset pattern 802.

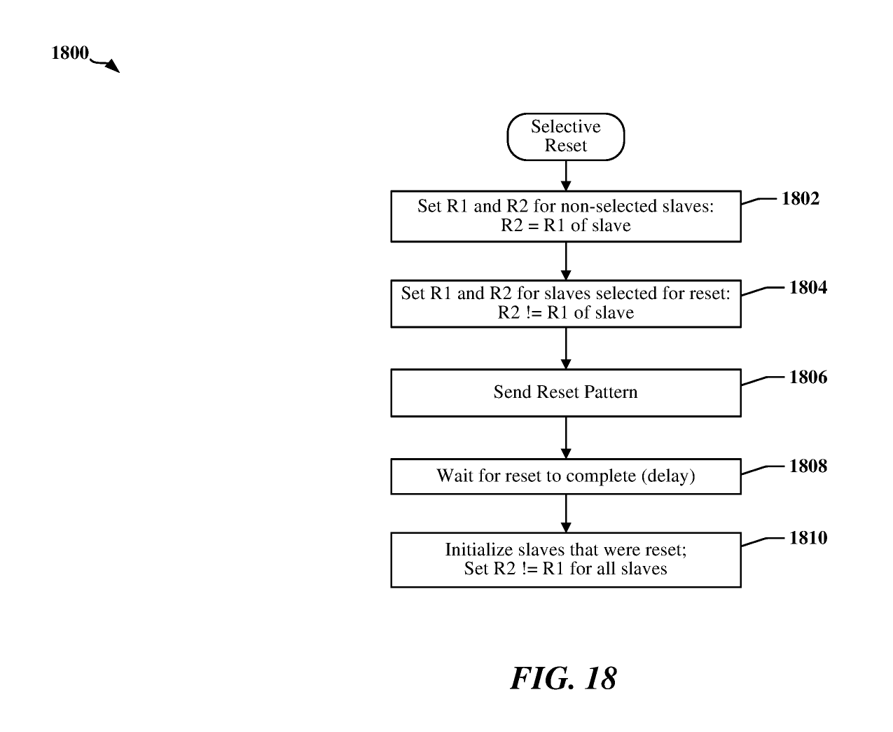

FIG. 18 is a flowchart 1800 illustrating the configuration of a plurality of slave devices by a master device in order to selectively cause the reset controller 904 of some slave devices to assert the reset signal 920 after detecting a device reset pattern 802, and the reset controller 904 of other slave devices to ignore the device reset pattern 802. The slave device may incorporate certain of the features of the peripheral device 900 illustrated in FIG. 9, for example.

At block 1802, the master device may configure the R1 register 916 and the R2 register 918 of a first group of slave devices to have the same value. At block 1804, the master device may configure the R1 register 916 and the R2 register 918 of a second group of slave devices to have a different value.

At block 1806, the master device may transmit the device reset pattern 802. The first group of slave devices may ignore the device reset pattern 802. The second group of slave devices may respond to the device reset pattern 802 by asserting their respective reset signals 920.

At block 1808, the master may wait for a period of time to permit the second group of slave devices to complete a reset operation.

At block 1810, the master device may configure the R1 register 916 and the R2 register 918 of the first group of slaves and the second group of slaves to have different values. All slaves are then able to respond to the device reset pattern 802 by asserting their respective reset signals 920.

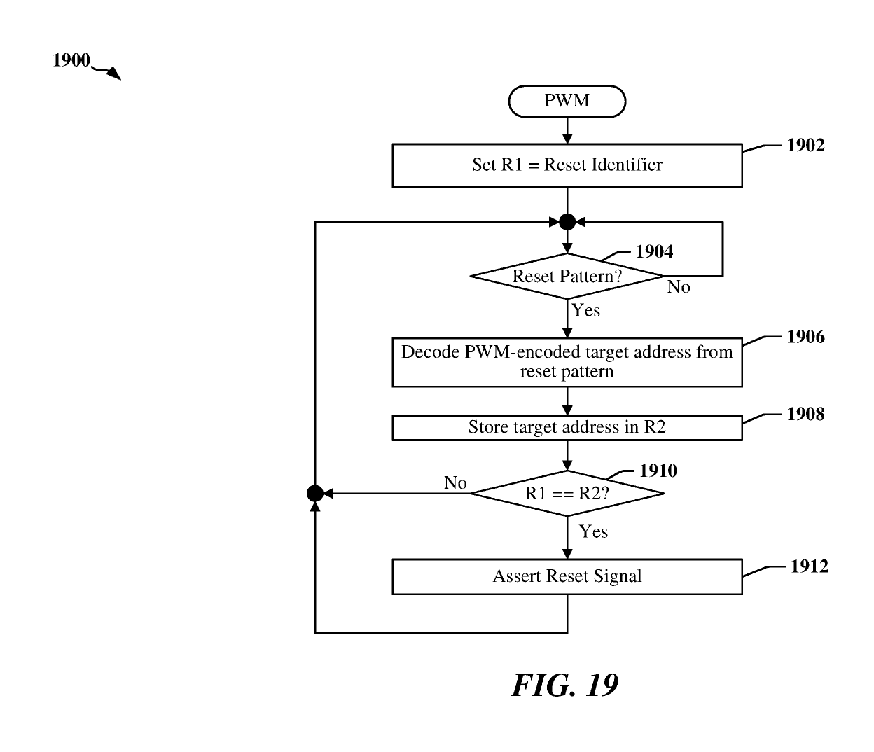

FIG. 19 is a flowchart 1900 illustrating a hard-reset process implemented at a slave device and controlled through PWM-modulated signaling transmitted by a host device 1500, which may be incorporated in an application processor, or the like. The slave device may incorporate certain of the features of the peripheral device 1100 illustrated in FIG. 11, for example. In some instances, the hard-reset process may be executed using a state-machine, sequencer, or other processing device. At block 1902, the peripheral device 1100 may configure a first register (the R1 register 1116) in its reset controller 1104 in response to a command from the host device or in accordance with a power-on procedure associated with the slave device. The reset controller 1104 in the peripheral device 1100 can operate autonomously of the I3C interface 1102 (or another interface associated with a serial bus). At block 1904, the reset controller 1104 may monitor the data line 712 and clock line 714 to determine whether a device reset pattern 802 has been detected on the data line 712 and/or clock line 714.

Upon detecting the device reset pattern 802 at block 1904, the reset controller 1104 may determine whether information is encoded in the device reset pattern 802 at block 1906. In one example, information may be encoded in pulse-width modulated pulses, as described in relation to FIG. 12. In some examples, the encoded information may include a device identifier, a reset address, or other information that identifies a device to be reset. The encoded information may be decoded and stored in a second register (the R2 register 1118) at block 1908. At block 1910, the reset controller 1104 may determine whether the peripheral device 1100 is targeted by the device reset pattern 802. In one example, the peripheral device 1100 may determine that the peripheral device 1100 is targeted by the device reset pattern 802 when the value of the R1 register 1116 matches the value of the R2 register 1118. In another example, the peripheral device 1100 may determine that the peripheral device 1100 is targeted by the device reset pattern 802 when the bits in a portion of the R1 register 1116 matches the bits in a corresponding portion of the R2 register 1118. In another example, the peripheral device 1100 may determine that the peripheral device 1100 is targeted by the device reset pattern 802 when the R1 register 1116 does not match the R2 register 1118.

If the reset controller 1104 has determined that the peripheral device 1100 is targeted by the device reset pattern 802, then the reset controller 1104 may assert a reset signal 1120 that causes reset of one or more processors, circuits and/or modules of the peripheral device 1100 at block 1912. If the peripheral device 1100 is not targeted by the device reset pattern 802, the reset controller 1104 may wait for the next device reset pattern 802 at block 1904.

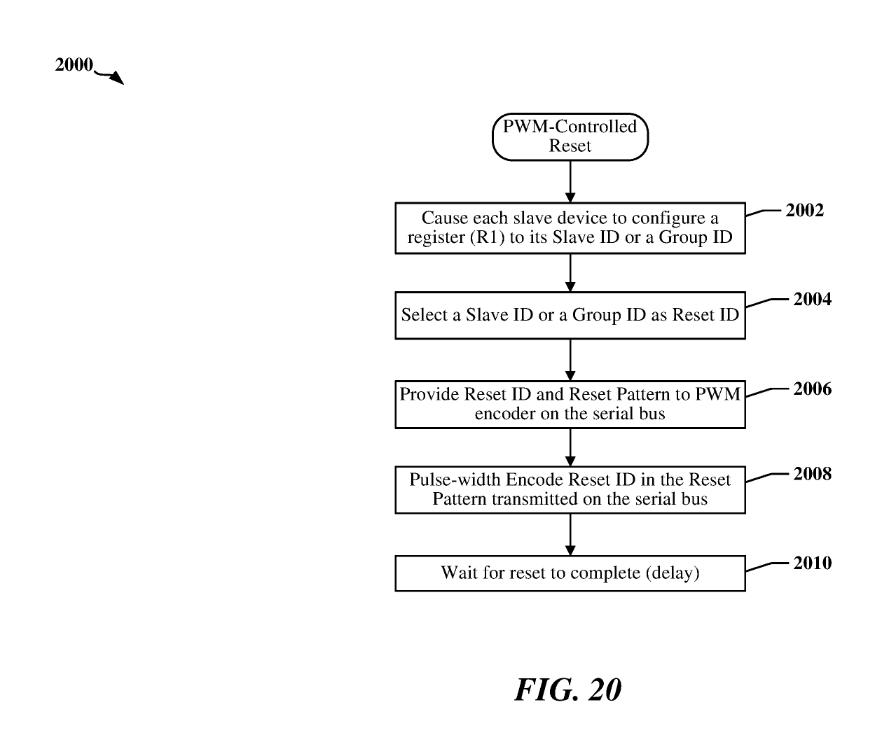

FIG. 20 is a flowchart 2000 illustrating the configuration of a plurality of slave devices by a host device 1500 (see FIG. 15) in order to selectively cause the reset controller 1104 (see FIG. 11) of some slave devices to assert the reset signal 1120 after detecting a device reset pattern 802, and the reset controller 1104 of other slave devices to ignore the device reset pattern 802.

At block 2002, the host device 1500 may cause each slave device to configure the R1 register 1116. The host device 1500 may transmit a unique reset address to each slave device. In some instances, the host device 1500 may transmit a common reset address to multiple slave devices, where the reset address operates as a group address. In some instances, one or more slave devices may be programmed with a unique identifier in accordance with the protocol used by the slave devices to communicate through a serial bus. At block 2004, the host device 1500 may determine that one or more slave devices are to be reset. A slave device may be selected for reset when it becomes unresponsive, or reports an internal error condition. In some instances, the selection of slave devices for reset may precede the transmission of reset addresses if the slave device is responsive but reports the internal error condition.

At block 2006, the host device 1500 may provide a reset address to a PWM encoder 1508 (see FIG. 15). The host device 1500 may also provide a reset pattern 802 to the PWM encoder 1508. In some instances, the PWM encoder 1508 may generate the reset pattern 802. At block 2008, the host device 1500 may cause the PWM encoder 1508 to encode the reset address in the reset pattern 802 using PWM. In one example, the PWM encoder 1508 may encode the reset address in pulse-width modulated pulses, as described in relation to FIG. 12.

At block 2010, the host device 1500 may wait for a period of time to permit one or more slave devices to complete a reset operation.

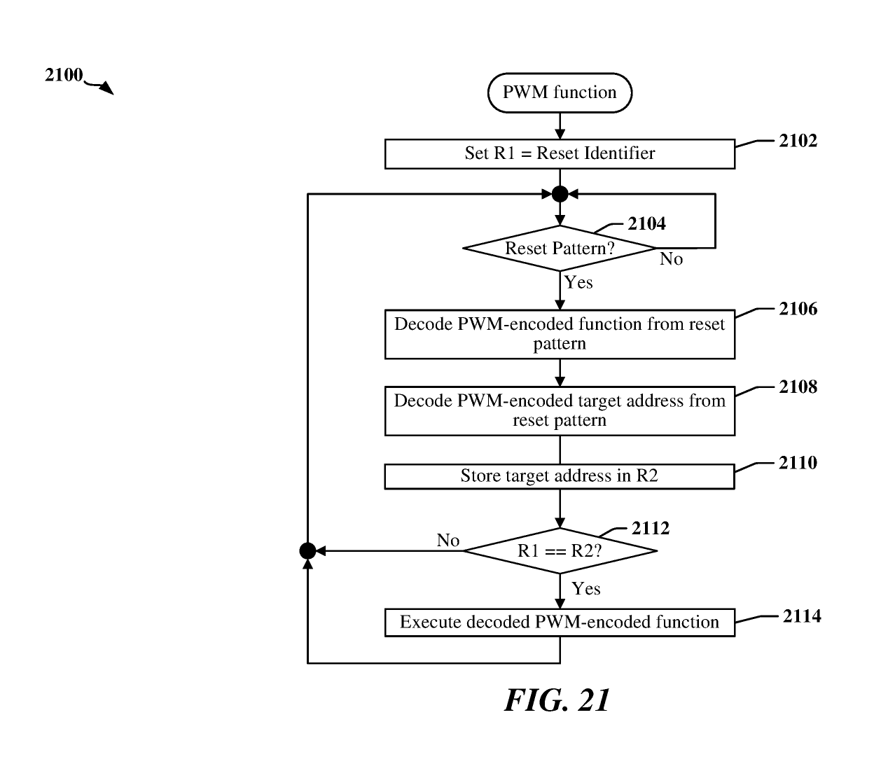

FIG. 21 is a flowchart 2100 illustrating a process implemented at a slave device, in which generation of certain control signals at the slave device may be controlled through PWM-modulated signaling transmitted by a host device 1500 (see FIG. 15). The host device 1500 may be incorporated in an application processor, or the like. The slave device may incorporate certain of the features of the peripheral device 1400 illustrated in FIG. 14, for example. In some instances, the process may be executed using a state-machine, sequencer, or other processing device. At block 2102, the peripheral device 1400 may configure a first register (the R1 register 1116) in its reset controller 1404 in response to a command from the host device or in accordance with a power-on procedure associated with the slave device. The reset controller 1404 in the peripheral device 1400 can operate autonomously of the I3C interface 1402 (or another interface associated with a serial bus). At block 2104, the reset controller 1404 may monitor the data line 712 and clock line 714 to determine whether a device reset pattern 802 has been detected on the data line 712 and/or clock line 714.

Upon detecting the device reset pattern 802 at block 2104, the reset controller 1404 may determine whether information is encoded in the device reset pattern 802 at block 2106. In one example, information may be encoded in pulse-width modulated pulses, as described in relation to FIG. 12. In some examples, the encoded information may include a command or function code that may be used to determine the signaling state of one or more control signals 1420 in the peripheral device 1400. The control signals 1420 may include a reset signal, and the process described by the flowchart 2100 may follow closely certain aspects of the flowchart 1900 in FIG. 19. The reset controller 1404 may include a PWM decoder 1412 that may be used to extract the command or function code. At block 2108, the reset controller 1404 may decode a device identifier, a reset address, or other information that identifies a device to be reset from the PWM-encoded information. The encoded device identifier may be decoded and stored in a second register (the R2 register 1418) at block 2110. At block 2110, the reset controller 1404 may determine whether the peripheral device 1400 is targeted by the device reset pattern 802. In one example, the peripheral device 1400 may determine that the peripheral device 1400 is targeted by the device reset pattern 802 when the value of the R1 register 1416 matches the value of the R2 register 1418. In another example, the peripheral device 1400 may determine that the peripheral device 1400 is targeted by the device reset pattern 802 when the bits in a portion of the R1 register 1416 matches the bits in a corresponding portion of the R2 register 1418. In another example, the peripheral device 1400 may determine that the peripheral device 1400 is targeted by the device reset pattern 802 when the R1 register 1416 does not match the R2 register 1418.

If the reset controller 1404 has determined that the peripheral device 1400 is targeted by the device reset pattern 802, then the reset controller 1404 may configure the signaling state of one or more signals 1420 within the peripheral device 1400. In one example, the one or more signals 1420 includes a reset signal that causes reset of one or more processors, circuits and/or modules of the peripheral device 1400 at block 2114. In another example, the one or more signals 1420 includes a power-control signal that causes one or more processors, circuits and/or modules of the peripheral device 1400 to enter or exit a sleep mode or an active mode of operation at block 2112. If the peripheral device 1400 is not targeted by the device reset pattern 802, the reset controller 1404 may wait for the next device reset pattern 802 at block 2104.

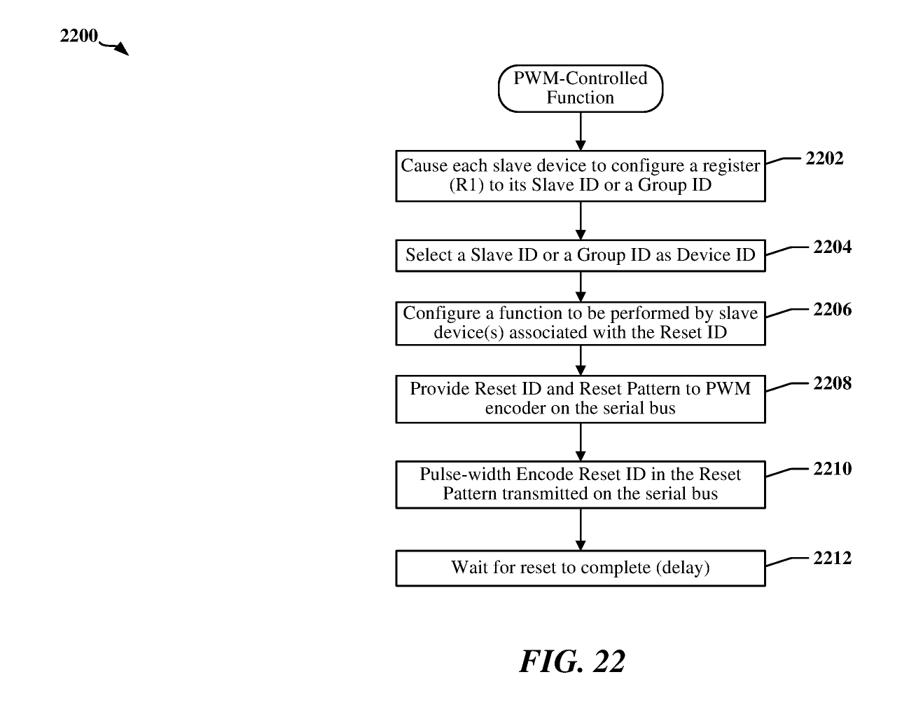

FIG. 22 is a flowchart 2200 illustrating the configuration of a plurality of slave devices by a host device 1500 (see FIG. 15) in order to selectively cause the reset controller 1404 (see FIG. 14) of some slave devices to assert, de-assert or change one or more control signals 1420 in the peripheral device 1400 after detecting a device reset pattern 802, and the reset controller 1404 of other slave devices to ignore the device reset pattern 802.

At block 2202, the host device 1500 may cause each slave device to configure the R1 register 1416. The host device 1500 may transmit a unique device identifier address to each slave device. In some instances, the host device 1500 may transmit a common identifier to multiple slave devices, where the common identifier operates as a group address. In some instances, one or more slave devices may be programmed with a unique identifier in accordance with the protocol used by the slave devices to communicate through a serial bus. At block 2204, the host device 1500 may determine that one or more slave devices are to be addressed. In one example, a slave device may be selected for reset when it becomes unresponsive, or reports an internal error condition. In another example, one or more slave devices may be selected for addressing, where the addressed devices may be forced into a low-power mode of operation.

At block 2206, the host device 1500 may select a configuration of signaling states of the one or more control signals 1420.

At block 2208, the host device 1500 may provide a device identifier or slave address to a PWM encoder 1508. The host device 1500 may also provide a reset pattern 802 to the PWM encoder 1508. In some instances, the PWM encoder 1508 may generate the reset pattern 802. At block 2210, the host device 1500 may cause the PWM encoder 1508 to encode the reset address in the reset pattern 802 using PWM. In one example, the PWM encoder 1508 may encode the reset address in pulse-width modulated pulses, as described in relation to FIG. 12.

At block 2212, the host device 1500 may wait for a period of time to permit one or more slave devices to complete a programmed operation initiated by the signaling state configured for the one or more control signals 1420.

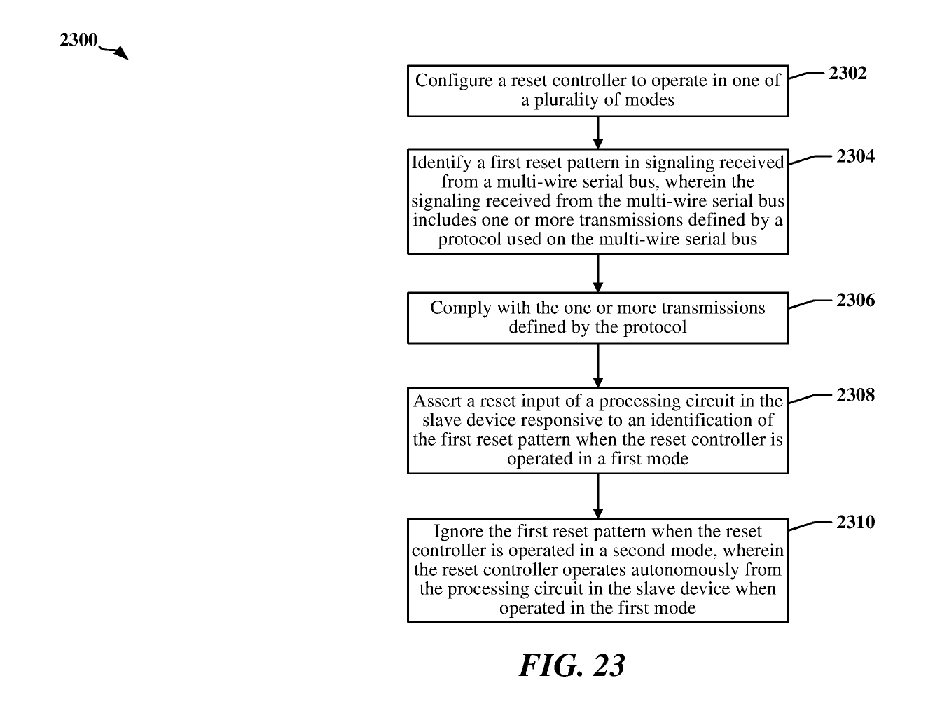

FIG. 23 is a flowchart 2300 of a method that may be performed at a slave device coupled to a serial bus. The slave device may be configured to communicate in accordance with I3C protocols.

At block 2302, the slave device may configure a reset controller to operate in one of a plurality of modes.

At block 2304, the slave device may identify a first reset pattern in signaling received from a multi-wire serial bus. The signaling received from the multi-wire serial bus includes one or more transmissions defined by a protocol used on the multi-wire serial bus. The first reset pattern is ignored by a second slave device that is operating in accordance with I2C protocols. The signaling received from the multi-wire serial bus may include one or more transmissions defined by an I3C protocol.

At block 2306, the slave device may comply with the one or more transmissions defined by the protocol.

At block 2308, the slave device may assert a reset input of a processing circuit in the slave device responsive to an identification of the first reset pattern when the reset controller is operated in a first mode.

At block 2310, the slave device may ignore the first reset pattern when the reset controller is operated in a second mode. The reset controller may operate autonomously from the processing circuit in the slave device when operated in the first mode.

In some examples, configuring the reset controller includes configuring a reset address corresponding to the slave device in a first register of the reset controller, and configuring a gating value in a register of the reset controller. The reset controller may operate in the second mode when the first register and the second register have a same value. The reset controller may operate autonomously in the first mode when the first register and the second register have different values.

In some examples, the reset controller may configure one or more reset addresses in one or more reset address registers of the reset controller, and may configure a gating value in a gate register of the reset controller. The reset controller may operate in the second mode when the one or more reset address registers and the gate register have a same value. The reset controller may operate autonomously in the first mode when at least one reset address register and the gate register have different values.

In some examples, the reset controller may configure a reset address in a reset address register of the reset controller, and may configure one or more gating values in one or more gate registers of the reset controller. The reset controller may operate in the second mode when the reset address register and the one or more gate registers have a same value. The reset controller may operate autonomously in the first mode when the reset address register and at least one gate register have different values.

In one example, the reset controller operates autonomously in the first mode after a power-on initialization of the first device.

In various examples, the slave device may modify operation of the processing circuit in the slave device based on information encoded in a second reset pattern provided in the signaling received from the multi-wire serial bus. The slave device may decode an identifier from the second reset pattern using a pulse width modulation decoder, and assert the reset input of the processing circuit in the slave device when the identifier is associated with the slave device. The slave device may decode a command code from the second reset pattern using a pulse width modulation decoder, and modify operation of the processing circuit in the slave device based on the command code. The slave device may cause the processing circuit in the slave device to enter a sleep mode of operation in response to the command. The reset controller may remain powered on and operating autonomously from the processing circuit in the slave device when the processing circuit in the slave device has entered a sleep mode of operation.

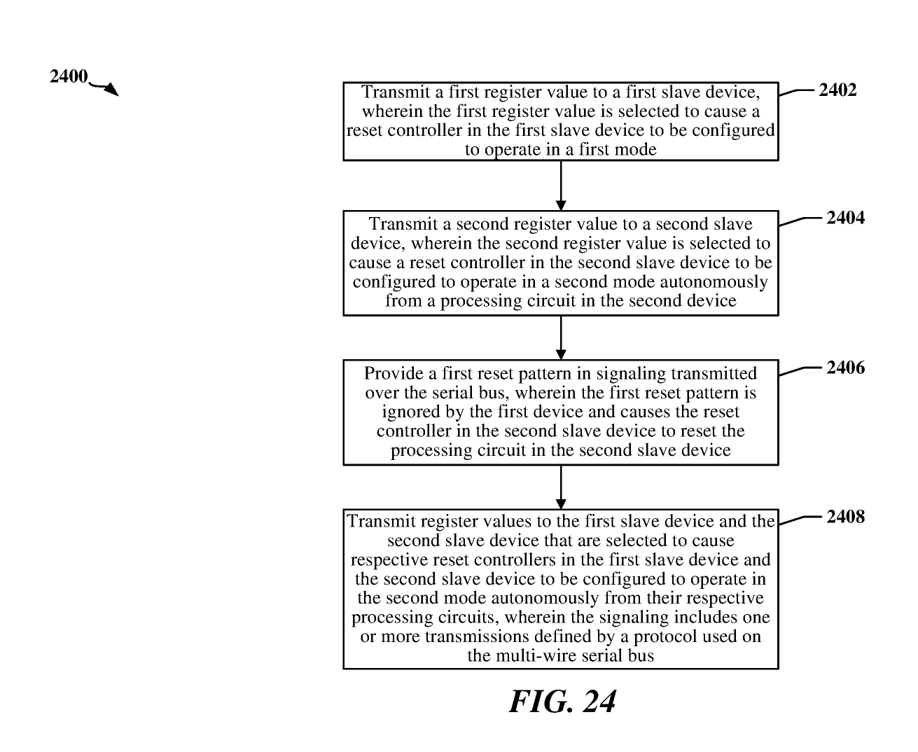

FIG. 24 is a flowchart 2400 illustrating certain operations of a host device coupled to a serial bus. At block 2402, the host device may transmit a first register value to a first slave device. The first register value may be selected to cause a reset controller in the first slave device to be configured to operate in a first mode.

At block 2404, the host device may transmit a second register value to a second slave device. The second register value may be selected to cause a reset controller in the second slave device to be configured to operate in a second mode autonomously from a processor in the second device.

At block 2406, the host device may provide a first reset pattern in signaling transmitted over the serial bus. The first reset pattern may be ignored by the first device and may cause the reset controller in the second slave device to reset the processor in the second slave device. The signaling includes one or more transmissions defined by a protocol used on the multi-wire serial bus. The first reset pattern may be ignored by a second slave device that is operating in accordance with I2C protocols. The signaling transmitted over the serial bus may include one or more transmissions defined by an I3C protocol.

At block 2408, the host device may transmit register values to the first slave device and the second slave device that are selected to cause respective reset controllers in the first slave device and the second slave device to be configured to operate in the second mode autonomously from their respective processors.

In some examples, the first register value includes a gating value identical to a first identifier maintained by the reset controller in the first slave device. The second register value may include a gating value identical to a second identifier maintained by the reset controller in the second slave device. Modes of operation of reset controllers in the first slave device and the second slave device may be determined based on a comparison of respective identifiers and corresponding gating values.

In one example, the reset controller of the first device may be configured to operate in the second mode autonomously from the processor in the second device after a power-on initialization of the first device.

In some examples, the host device may provide a second reset pattern in the signaling transmitted over the serial bus, and encode information in the second reset pattern that is configured to cause modification of operation of a processor in at least one slave device. The host device may encode information in the second reset pattern by encoding an identifier using a pulse width modulation encoder. The identifier may be selected to cause an autonomous reset controller in the at least one slave device to reset a processor in the at least one slave device. The host device may encode information in the second reset pattern by encoding a command code using a pulse width modulation encoder. The command code may be selected to cause an autonomous reset controller in the at least one slave device to modify an operation of a processor in the at least one slave device. The command code may be selected to cause the processor in the at least one slave device to enter a sleep mode of operation in response to the command.

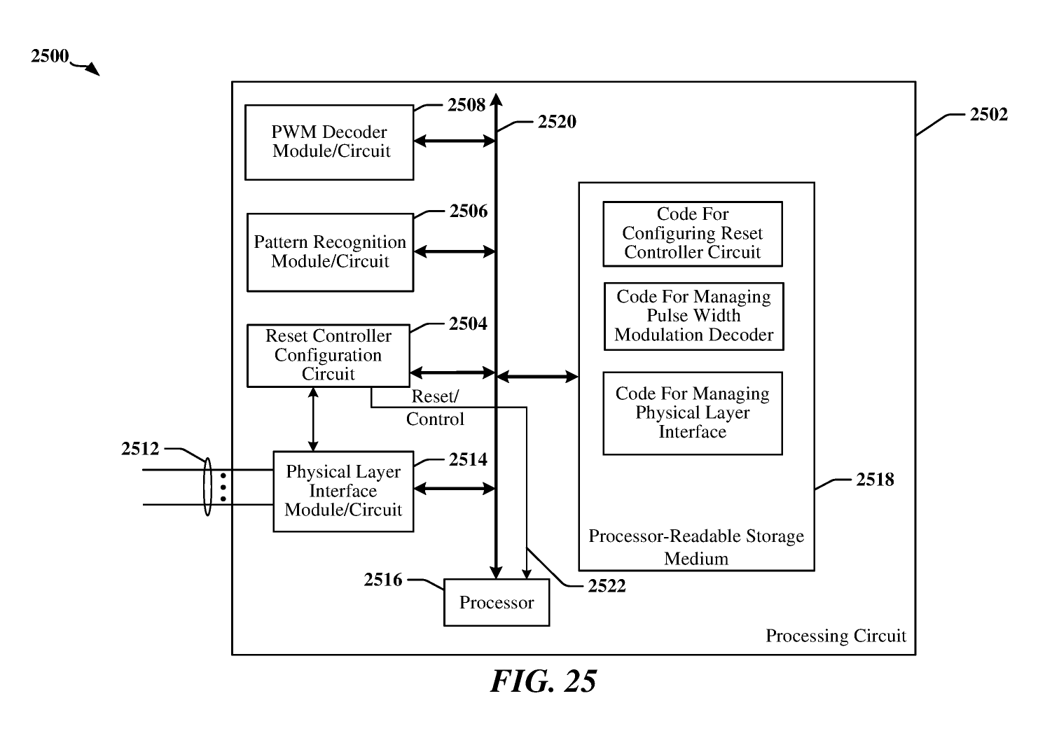

FIG. 25 is a diagram illustrating a simplified example of a hardware implementation for an apparatus 2500 employing a processing circuit 2502. The processing circuit typically has a controller or processor 2516 that may include one or more microprocessors, microcontrollers, digital signal processors, sequencers and/or state machines. The processing circuit 2502 may be implemented with a bus architecture, represented generally by the bus 2520. The bus 2520 may include any number of interconnecting buses and bridges depending on the specific application of the processing circuit 2502 and the overall design constraints. The bus 2520 links together various circuits including one or more processors and/or hardware modules, represented by the controller or processor 2516, the modules or circuits 2504, 2506 and 2508, and the computer-readable storage medium 2518. The apparatus may be coupled to a multi-wire communication link using a physical layer circuit 2514. The physical layer circuit 2514 may operate the multi-wire communication link 2512 to support communications in accordance with an I2C and/or I3C protocol. The bus 2520 may also link various other circuits such as timing sources, peripherals, voltage regulators, and power management circuits, which are well known in the art, and therefore, will not be described any further.

The processor 2516 is responsible for general processing, including the execution of software, code and/or instructions stored on the computer-readable storage medium 2518. The computer-readable storage medium may include a non-transitory storage medium. The software, when executed by the processor 2516, causes the processing circuit 2502 to perform the various functions described supra for any particular apparatus. The computer-readable storage medium may be used for storing data that is manipulated by the processor 2516 when executing software. The processing circuit 2502 further includes at least one of the modules 2504, 2506 and 2508. The modules 2504, 2506 and 2508 may be software modules running in the processor 2516, resident/stored in the computer-readable storage medium 2518, one or more hardware modules coupled to the processor 2516, or some combination thereof. The modules 2504, 2506 and 2508 may include microcontroller instructions, state machine configuration parameters, or some combination thereof.

In one configuration, the apparatus 2500 includes modules and/or circuits 2508 adapted to configure a reset controller 2504 to operate in one of a plurality of modes. In one mode, the reset controller 2504 may be configured to assert a reset and/or other control signal 2522 received by the processor 2516. The apparatus 2500 may include modules and/or circuits 2506 configured to identify a first reset pattern in signaling received from the multi-wire serial bus, where the signaling received from the multi-wire communication link 2512 includes one or more transmissions defined by a protocol used on the multi-wire communication link 2512. The apparatus 2500 may include modules and/or circuits 2506 configured to decode information from a second reset pattern using PWM, where the operation of the processing circuit 2502 and/or processor 2516 based on the decoded information.

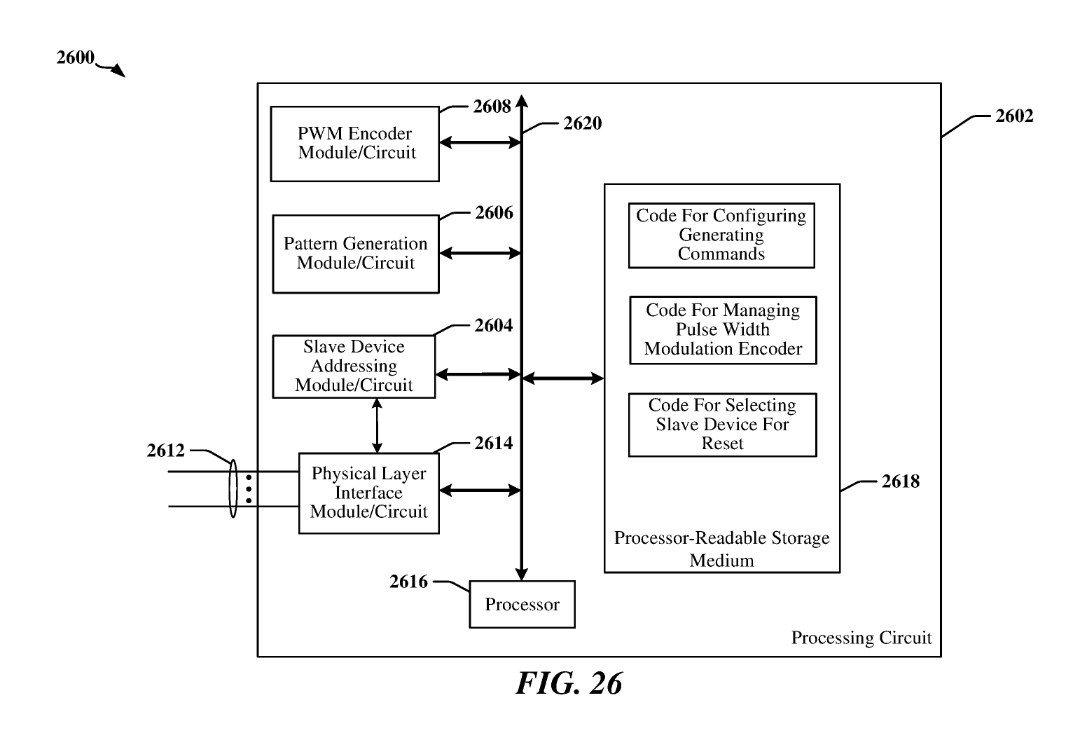

FIG. 26 is a diagram illustrating a simplified example of a hardware implementation for an apparatus 2600 employing a processing circuit 2602. The processing circuit typically has a controller or processor 2616 that may include one or more microprocessors, microcontrollers, digital signal processors, sequencers and/or state machines. The processing circuit 2602 may be implemented with a bus architecture, represented generally by the bus 2620. The bus 2620 may include any number of interconnecting buses and bridges depending on the specific application of the processing circuit 2602 and the overall design constraints. The bus 2620 links together various circuits including one or more processors and/or hardware modules, represented by the controller or processor 2616, the modules or circuits 2604, 2606 and 2608, and the computer-readable storage medium 2618. The apparatus may be coupled to a multi-wire communication link using a physical layer circuit 2614. The physical layer circuit 2614 may operate the multi-wire communication link 2612 to support communications in accordance with an I2C and/or I3C protocol. The bus 2620 may also link various other circuits such as timing sources, peripherals, voltage regulators, and power management circuits, which are well known in the art, and therefore, will not be described any further.

The processor 2616 is responsible for general processing, including the execution of software, code and/or instructions stored on the computer-readable storage medium 2618. The computer-readable storage medium may include a non-transitory storage medium. The software, when executed by the processor 2616, causes the processing circuit 2602 to perform the various functions described supra for any particular apparatus. The computer-readable storage medium may be used for storing data that is manipulated by the processor 2616 when executing software. The processing circuit 2602 further includes at least one of the modules 2604, 2606 and 2608. The modules 2604, 2606 and 2608 may be software modules running in the processor 2616, resident/stored in the computer-readable storage medium 2618, one or more hardware modules coupled to the processor 2616, or some combination thereof. The modules 2604, 2606 and 2608 may include microcontroller instructions, state machine configuration parameters, or some combination thereof.

In one configuration, the apparatus 2600 includes modules and/or circuits 2604 configured to transmit register values to one or more slave devices in order to configure a mode of operation of the salve devices. In one mode, a reset controller in a slave device is configured to operate autonomously from a processing circuit in the slave device. The apparatus 2600 includes modules and/or circuits 2606 configured to provide reset patterns in signaling transmitted over the multi-wire communication link 2612, where certain reset patterns may cause a slave device to reset the processing circuit in the slave device. The apparatus 2600 optionally includes modules and/or circuits 2608 configured to encode information in certain patterns provided in signaling transmitted over the multi-wire communication link 2612, where the encoded information is configured to cause modification of operation of a processor in at least one slave device.

In some examples, the apparatus 2600 includes a processing circuit 2602, and/or a communication interface coupled to the multi-wire communication link 2612 through the physical layer circuit 2614. In one example the communication interface may be responsive to the processing circuit 2602. The communication interface may respond to certain transmissions that are compliant or compatible with one or more protocols used on the multi-wire communication link 2612. For example, the transmissions may include the signaling 800 and/or the targeted device reset pattern 1200 disclosed herein. The apparatus 2600 may include or be coupled to a reset controller coupled to the multi-wire communication link 2612 and may be configurable to operate in one or more of a plurality of modes. In one example, the reset controller may be configured to identify a first reset pattern in signaling received from the multi-wire serial bus. The reset controller may cause a reset input of the processing circuit 2602 and/or the communication interface to be asserted responsive to an identification of the first reset pattern when the reset controller is operated in a first mode, and ignore the first reset pattern when the reset controller is operated in a second mode. The reset controller may operate autonomously from the processing circuit 2602 and/or the communication interface.

The reset controller may include a plurality of registers including a reset address register and a gate register, and a comparator configured to provide an enable signal indicating whether certain bits in the reset address register match corresponding bits in the gate register. The reset controller may be adapted to operate in the second mode when the one or more reset address registers and the gate register have a same value, and operate in the first mode when at least one reset address register and the gate register have different values.

The apparatus 2600 may include a pulse width modulation decoder (e.g., the modules and/or circuits 2608) configured to decode information encoded in a second reset pattern provided in the signaling received from the multi-wire serial bus. The reset controller may be adapted to assert the reset input of the processing circuit when the information includes an identifier associated with the apparatus. The reset controller may be adapted to modify an operation of the processing circuit based on a command code included in the information.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a slave device coupled to a serial bus, comprising:
configuring a reset controller to operate in one of a plurality of modes;
identifying a first reset pattern in signaling received from a multi-wire serial bus, wherein the signaling received from the multi-wire serial bus includes one or more transmissions defined by a protocol used on the multi-wire serial bus;
complying with the one or more transmissions defined by the protocol;
asserting a reset input of a processing circuit in the slave device responsive to an identification of the first reset pattern when the reset controller is operated in a first mode; and
ignoring the first reset pattern when the reset controller is operated in a second mode,
wherein the reset controller operates autonomously from the processing circuit in the slave device.

2. The method of claim 1, wherein the first reset pattern is ignored by a second slave device that is operating in accordance with I2C protocols.

3. The method of claim 1, wherein configuring the reset controller comprises:
configuring one or more reset addresses in one or more reset address registers of the reset controller; and
configuring a gating value in a gate register of the reset controller,
wherein the reset controller operates in the second mode when the one or more reset address registers and the gate register have a same value, and
wherein the reset controller operates autonomously in the first mode when at least one reset address register and the gate register have different values.

4. The method of claim 1, wherein configuring the reset controller comprises:
configuring a reset address in a reset address register of the reset controller; and
configuring one or more gating values in one or more gate registers of the reset controller,
wherein the reset controller operates in the second mode when the reset address register and the one or more gate registers have a same value, and
wherein the reset controller operates autonomously in the first mode when the reset address register and at least one gate register have different values.

5. The method of claim 1, wherein the reset controller operates autonomously in the first mode after a power-on initialization of the slave device.

6. The method of claim 1, and further comprising:
modifying operation of the processing circuit in the slave device based on information encoded in a second reset pattern provided in the signaling received from the multi-wire serial bus.

7. The method of claim 6, further comprising:
decoding an identifier from the second reset pattern using a pulse width modulation decoder; and
asserting the reset input of the processing circuit in the slave device when the identifier is associated with the slave device.

8. The method of claim 6, and further comprising:
decoding a command code from the second reset pattern using a pulse width modulation decoder; and
modifying operation of the processing circuit in the slave device based on the command code.

9. The method of claim 8, and further comprising:
causing the processing circuit in the slave device to enter a sleep mode of operation in response to the command.

10. The method of claim 1, where the reset controller remains powered on and operating autonomously from the processing circuit in the slave device when the processing circuit in the slave device has entered a sleep mode of operation.

11. The method of claim 1, where the signaling received from the multi-wire serial bus includes one or more transmissions defined by an I3C protocol.

12. An apparatus, comprising:
a processing circuit;
a communication interface responsive to the processing circuit and adapted to be coupled to a multi-wire serial bus and configured to comply with one or more transmissions defined by protocols used on the multi-wire serial bus; and
a reset controller coupled to the serial bus and configurable to operate in one or more of a plurality of modes, wherein the reset controller is configured to:
identify a first reset pattern in signaling received from the multi-wire serial bus, wherein the signaling received from the multi-wire serial bus includes one or more transmissions defined by a first protocol used on the multi-wire serial bus;
cause a reset input of the processing circuit responsive to an identification of the first reset pattern when the reset controller is operated in a first mode; and
ignore the first reset pattern when the reset controller is operated in a second mode,
wherein the reset controller operates autonomously from the processing circuit.

13. The apparatus of claim 12, wherein the reset controller comprises:
a plurality of registers including a reset address register and a gate register; and
a comparator configured to provide an enable signal indicating whether certain bits in the reset address register match corresponding bits in the gate register,
wherein the reset controller is adapted to:
operate in the second mode when the one or more reset address registers and the gate register have a same value; and
operate autonomously in the first mode when at least one reset address register and the gate register have different values.

14. The apparatus of claim 12, and further comprising:
a pulse width modulation decoder configured to decode information encoded in a second reset pattern provided in the signaling received from the multi-wire serial bus.

15. The apparatus of claim 14, wherein the reset controller is adapted to:
assert the reset input of the processing circuit when the information includes an identifier associated with the apparatus.

16. The apparatus of claim 14, wherein reset controller is adapted to:
modify an operation of the processing circuit based on a command code included in the information.

17. A method performed at a host device coupled to a serial bus, comprising:
transmitting a first register value to a first slave device, wherein the first register value is selected to cause a reset controller in the first slave device to be configured to operate in a first mode;
transmitting a second register value to a second slave device, wherein the second register value is selected to cause a reset controller in the second slave device to be configured to operate in a second mode autonomously from a processing circuit in the second slave device;
providing a first reset pattern in signaling transmitted over the serial bus, wherein the first reset pattern is ignored by the first slave device and causes the reset controller in the second slave device to reset the processing circuit in the second slave device; and
transmitting register values to the first slave device and the second slave device that are selected to cause respective reset controllers in the first slave device and the second slave device to be configured to operate in the second mode autonomously from their respective processing circuits,
wherein the signaling includes one or more transmissions defined by a protocol used on the serial bus.

18. The method of claim 17, wherein the first reset pattern is ignored by a second slave device that is operating in accordance with I2C protocols.

19. The method of claim 17, wherein:
the first register value comprises a gating value identical to a first identifier maintained by the reset controller in the first slave device;
the second register value comprises a gating value identical to a second identifier maintained by the reset controller in the second slave device; and
modes of operation of reset controllers in the first slave device and the second slave device are determined based on a comparison of respective identifiers and corresponding gating values.

20. The method of claim 17, wherein the reset controller of the first slave device is configured to operate in the second mode autonomously from the processing circuit in the second slave device after a power-on initialization of the first slave device.

21. The method of claim 17, and further comprising:
providing a second reset pattern in the signaling transmitted over the serial bus; and
encoding information in the second reset pattern that is configured to cause modification of operation of a processing circuit in at least one slave device.

22. The method of claim 21, wherein encoding information in the second reset pattern comprises:
encoding an identifier using a pulse width modulation encoder,
wherein the identifier is selected to cause an autonomous reset controller in the at least one slave device to reset a processing circuit in the at least one slave device.

23. The method of claim 21, wherein encoding information in the second reset pattern comprises:
encoding a command code using a pulse width modulation encoder,
wherein the command code is selected to cause an autonomous reset controller in the at least one slave device to modify an operation of a processing circuit in the at least one slave device.

24. The method of claim 23, wherein the command code is selected to cause the processing circuit in the at least one slave device to enter a sleep mode of operation in response to the command.

25. The method of claim 17, where the signaling is transmitted over the serial bus includes one or more transmissions defined by an I3C protocol.

26. A processor-readable storage medium having one or more instructions which, when executed by at least one processing circuit, cause the at least one processing circuit to:
transmit a first register value to a first slave device coupled to a serial bus, wherein the first register value is selected to cause a reset controller in the first slave device to be configured to operate in a first mode;
transmit a second register value to a second slave device coupled to the serial bus, wherein the second register value is selected to cause a reset controller in the second slave device to be configured to operate in a second mode autonomously from a processing circuit in the second slave device;
provide a first reset pattern in signaling transmitted over the serial bus, wherein the first reset pattern is ignored by the first slave device and causes the reset controller in the second slave device to reset the processing circuit in the second slave device; and
transmit register values to the first slave device and the second slave device that are selected to cause respective reset controllers in the first slave device and the second slave device to be configured to operate in the second mode autonomously from their respective processing circuits,
wherein the signaling includes one or more transmissions defined by a protocol used on the serial bus.

27. The storage medium of claim 26, further comprising instructions that cause the at least one processing circuit to:
provide a second reset pattern in the signaling transmitted over the serial bus; and
encode information in the second reset pattern that is configured to cause modification of operation of a processing circuit in at least one slave device.

28. The storage medium of claim 26, further comprising instructions that cause the at least one processing circuit to:
encode an identifier using a pulse width modulation encoder,
wherein the identifier is selected to cause an autonomous reset controller in at least one slave device to reset a processing circuit in at least one slave device.

29. The storage medium of claim 26, further comprising instructions that cause the at least one processing circuit to:
encode a command code using a pulse width modulation encoder,
wherein the command code is selected to cause an autonomous reset controller in at least one slave device to modify an operation of a processing circuit in the at least one slave device.

30. The storage medium of claim 29, wherein the command code is selected to cause the processing circuit in the least one slave device to enter a sleep mode of operation in response to the command.
